(19) United States
(12) Patent Application Publication
(10) Pub. No.: US 2016/0050589 A1
(43) Pub. Date: Feb. 18, 2016

(54) AMBIENT NETWORK SENSING AND HANDOFF FOR DEVICE OPTIMIZATION IN HETEROGENEOUS NETWORKS

(71) Applicant: Samsung Electronics Co., Ltd., Suwon-si (KR)

(72) Inventor: Saeid Safavi, San Diego, CA (US)

(21) Appl. No.: 14/519,840

(22) Filed: Oct. 21, 2014

Related U.S. Application Data
(60) Provisional application No. 62/037,026, filed on Aug. 13, 2014.

(51) Int. Cl. H04W 36/00; H04W 36/30

(52) U.S. Cl. CPC H04W 36/0033; H04W 36/30

(57) ABSTRACT

Computer implemented methods, systems, and computer readable media provided herein may collect contextual information including parameter from a physical layer and a parameter from at least one other OSI layer. A handoff may be initiated based on the physical layer parameter and the at least one other OSI layer parameter.

### PRIORITY

This application claims priority to U.S. Provisional Application No. 62/037,026, filed on Aug. 13, 2014 and titled “Ambient Network Sensing and Handoff for Device Optimization in Heterogeneous Networks”, which is incorporated by reference herein in its entirety.

### FIELD OF THE INVENTION

The present disclosure relates to the field of networks and, in particular, network sensing in heterogeneous networks.

### BACKGROUND

As new mobile devices and networking technologies evolve, a need for integration of various applications and end-to-end services may become increasingly important. While advancements in wireless access technologies, networking, and content delivery have key roles in enabling such provisioning scenarios, these new trends may create a very challenging networking paradigm. In this regard, a major aspect of such evolution results in a growing number of users that require access to continuous services (e.g., audio or video streaming) while moving among different points of attachments (PoAs) to a network (e.g., internet, cellular, etc.), possibly with different connectivity technologies. This type of heterogeneous connectivity may result in a superposition or overlay of access networks of various architectures and topologies ranging from pico-cellular systems to macro-cellular systems covering a wide range of user applications and services. In addition, different access technologies (e.g. WLAN, Wi-Fi Direct, Sensor Networks, Bluetooth, 60 GHz, etc.) are increasingly being integrated into client devices (or user devices) to enhance user experience and address bandwidth (BW), capacity, and coverage challenges. With proper network support this trend may increase service capabilities toward a concept of ubiquitous connectivity with a single multi-standard user terminal.

As cellular networks evolve to support heterogeneous architectures with ubiquitous connectivity, a high degree of adaptation, awareness, and flexibility may be required, particularly in radio access. At the same time, however, by moving from traditional concepts of macro-cell towards small cells with a number of femto cell overlays, operator control and management over access resources are becoming increasingly out of reach, particularly from an interference control perspective. This may be mainly driven by an unpredictable number and position of femto access points (FAPs), where interference management cannot be further handled by an operator through traditional network planning and optimization methodologies. A concerning byproduct of the integration of various applications and end-to-end services in a heterogeneous environment is a need for more components and processing power in mobile devices which can conflict with maintaining a tight device energy budget. Thus, there is a need for a solution which addresses all the concerns unaddressed by prior developments.

### SUMMARY

An embodiment of a computing system including at least one processor and a memory. The memory storing instructions configured to instruct the processor to collect contextual information including at least one parameter from a physical layer and at least one other open systems interconnection (OSI) layer. A handoff may be initiated based on the at least one parameter from the physical layer and the at least one other OSI layer.

An embodiment of a method of operating a computing system by collecting contextual information including at least one parameter from a physical layer and at least one other open systems interconnection (OSI) layer. The method may include initiating a handoff based on the at least one parameter from the physical layer and the at least one other OSI layer.

An embodiment of a method of operating a computing system by collecting contextual information including at least one parameter from a physical layer and at least one other open systems interconnection (OSI) layer. The method may include initiating a handoff based on the at least one parameter from the physical layer and the at least one other OSI layer contextual information.

Many other features and embodiments of the invention will be apparent from the accompanying drawings and from the following detailed description.

### BRIEF DESCRIPTION OF THE DRAWINGS

FIG. 1 illustrates a block diagram of an example ambient network sensing (ANS) system, according to a certain embodiments.

FIG. 2 illustrates an exemplary system for performing a device-centric context-aware handoff, according to certain embodiments.

FIG. 3 illustrates a diagram of an exemplary device state and handoff recommendation module, according to certain embodiments.

FIG. 4 illustrates an example block diagram of a high level architecture of a system for ambient network sensing system, according to certain embodiments.

FIG. 5 illustrates an example block diagram of a context-aware handoff and execution (CAHE) module and a context manager (CM) module, according to certain embodiments.

FIG. 6 illustrates an example ecosystem, according to certain embodiments.

FIG. 7 illustrates a block diagram of an exemplary partitioning of context collection, analysis, and management mechanisms between a client device and a network edge device, according to certain embodiments.

FIG. 8 illustrates a flowchart for an example method of estimating energy for ambient network sensing, according to certain embodiments.

FIG. 9A illustrates an example RRC state machine diagram for LTE, according to certain embodiments.

FIG. 9B illustrates an example RRC state machine diagram for UMTS, according to certain embodiments.

FIG. 9C illustrates an example RRC state machine diagram for Wi-Fi, according to certain embodiments.

FIG. 9D illustrates an example RRC state machine diagram for Bluetooth (BT), according to certain embodiments.

FIG. 10 illustrates an exemplary flowchart for an ecosystem-based ambient network sensing (ANS) system for recommending a candidate network for vertical handoff, according to certain embodiments.

FIG. 11 illustrates a block diagram of an energy estimation method for a handoff decision, according to certain embodiments.

FIG. 12 illustrates an exemplary block diagram of an ANS system as middleware on a client device, according to certain embodiments.

FIG. 13 illustrates an example of a computer system, according to an embodiment.

The figures depict various embodiments of the present invention for purposes of illustration only, wherein the figures use like reference numerals to identify like elements. One skilled in the art will readily recognize from the following discussion that alternative embodiments of the structures and methods illustrated in the figures may be employed without departing from the principles of the invention described herein.

### DETAILED DESCRIPTION

Mobile devices may be resourcefully designed to help with support of variable QoS characteristics and seamless connectivity in multiple radio access technology (multi-RAT) or heterogeneous networking scenarios. However, significant energy consumption overheads may be simultaneously introduced at the mobile device. As these mobile devices are natively equipped with rechargeable batteries, energy consumption becomes a significant performance bottleneck for the user.

Mobile devices with capability to access different network technologies may perform horizontal and vertical handoffs (VHO). VHOs may include varying degrees of collaboration between different network entities. These network entities may interact and communicate in different forms, resulting in different processes in VHO. The interactions between the network entities may involve various types of integration of different radio access networks (RANs), such as tight coupling, loose coupling, and no coupling.

Tight coupling may include a tight integration between different networks involved in VHO. In such systems, the handoff process or a portion of it can be performed either by the network or the client device (or user equipment). This approach may be convenient when all networks are owned by the same operators.

Loose coupling may involve a network (e.g., cellular network) that has contributed to VHO but is not a main controller in the handoff. As such, the handoff process is client device driven. However, the network may provide some useful information (e.g., the coverage, network load, etc.) that may assist the handoff accuracy and speed.

With no coupling, the whole VHO process may be transparent to the networks involved. The handoff decision process, including the measurements and parameter collection, may be performed and evaluated by the client device without any support from the networks involved. Integration with no coupling may include challenges associated with addressing radio resource management and load balancing without network involvement. On the other hand, integration with tight coupling and loose coupling may be less efficient in terms of scalability and operator policy management.

Performance and energy bottlenecks of mobile applications may be caused, in part, from a lack of visibility into resource-oriented mobile execution environments and its complex interaction with behaviors of applications. In mobile computing environments, application developers may be unaware of the client device's network specific characteristics that occur in interactions with an application behavior. Such limitations potentially result in smartphone applications that are not wireless friendly. For example, an application may cause inefficient wireless channel utilization or device energy consumption, due to a lack of radio link transparency (e.g., lower layers protocol behavior) to the application. Therefore, there is a need for an increased level of device awareness in order to more efficiently make use of limited resources in mobile execution environments and complicated interactions with application behavior.

In certain embodiments, systems and methods are provided herein that enable client devices to utilize the inherent diversity of network connectivity options to find an optimal candidate network connectivity for a current application. The systems and methods may address multi-standard or heterogeneous client device (e.g., mobile device) challenges, particularly from a resource allocation and energy consumption perspective. The inherent diversity across multiple network resources and access technologies may be used for intra and inter technology switching, also known as horizontal and vertical handoff (or handover), even when the user is not on the move. More specifically, combined with traditional handoffs triggered by user movements, performance and efficiency may be significantly enhanced, both at the device level and the network level.

In an embodiment, network connectivity may be optimized by taking advantage of redundancy present in different RAN interfaces (e.g., 3G, 4G, cellular, Wi-Fi, Bluetooth, etc.) within client devices towards a performance enhancement of the client device. The performance enhancement may be based on one or more device-based performance metrics, such as battery savings or energy conservation, even when the user is not on the move. The system or method may also maintain or enhance user experience during a handoff by ensuring a seamlessness of application and session connectivity. The systems and methods may incorporate rich context within handoff execution while ensuring an application's QoS is maintained.

In an embodiment, cross-layer contextual information may enable direct access to, or accurate inference of, a device's radio resource control (RRC) state machine and an application's interaction with it. In this way, transparency to lower layer protocols may be improved. Such cross-layer contextual information collection may encompass both device and network related information. Cross-layer contextual information may comprise information or parameters from two or more open systems interconnection (OSI) layers such as user input/preferences layer, protocol layers (such as HTTP, transport, network, radio link, radio resource control states, or other similar layers), data link layer, session layer, presentation layer, application layer, MAC, and physical (PHY), or other similar layers. In some embodiments the protocol layers may be those affected or influenced by application behavior.

The layers providing contextual information may include various parameters. For example, physical layer may comprise parameters which may affect wireless or radio connectivity, such as radio frequency (RF) environmental factors (e.g., interference levels, noise, co-channel interference, adjacent interference, etc.), spectrum contamination, received signal strength indication (RSSI), bit error rate (BER), cell coverage, noise signal ratio (NSR), committed information rate (CIR), signal to interference ratio (SIR), etc. Exemplary parameters for the MAC/link layer may include channel access delay, number of retransmissions, clear channel assessment (CCA), threshold (in WiFi), etc. Exemplary parameters for a network layer may comprise types of network protocols supported (e.g., IP, mIP, mIPv6, etc.), detailed information for points of attachment (PoAs) such as supported network interfaces, max bandwidth, network preferences, billing information, handover rate, handover policies, etc. Exemplary parameters in a transport layer may include supported protocols (e.g., UDP, TCP, etc.). Exemplary parameters for an application layer may include required quality of service (QoS) parameters (e.g., delay, jitter, packet error rate, etc.), application type (e.g., switching between applications), sender bit rate, or other similar information. Exemplary parameters of user preferences may comprise price/cost of connection, quality of experience (QoE), battery life, privacy, security, preferred applications or services, or other similar information.

The contextual information may enable the selection of an optimal candidate network for handoff, by factoring true tradeoffs between important parameters such as QoS and energy consumption. A handoff may be performed based on cross-layer contextual information (e.g., a physical layer parameter and a parameter from at least one other OSI layer).

Device models may be implemented that factor various contexts from multiple layers of protocol (e.g., cross-layer) to create a network-related performance prediction platform that may reduce the gap between applications and lower layer protocols. Device optimization may be provided by proactively exploiting channel conditions in multiple radio connectivity choices.

The cross-layer contextual information may expose interactions among different protocol layers. In an embodiment, the protocol layers may include an application layer, a transport layer, RRC defining multiple channel states, and user input and interactions. The user input and interactions may, for instance, enable verification of a level of efficiency of resource usage for various client device applications. In this regard, accurately inferring lower layer RRC states and accurate quantification of resources energy consumptions may provide significant benefits to finding an optimal connectivity. For example, once an RRC state machine's interaction with a specific application is determined (or defined) and predicted, an optimal (e.g., best) available network connectivity candidate may be selected for a vertical (or horizontal) handoff.

In certain embodiments, ambient network sensing may include context collection, metric computation, network selection, and handoff (e.g., VHO). Context collection may include the collection of relevant contextual information (or contexts) across multiple protocol layers. Metric computation may include computing a device performance cost function per each available wireless network for device (or energy) optimization. Network selection may include selecting an optimal network that optimizes the above cost function, or a super set involving additional context. Handoff (e.g., VHO) may include performing a seamless handoff while ensuring that an application QoS is maintained or enhanced.

In certain embodiments, systems and methods may be provided that enable a portion of the computational load to another device other than the client device, such as a network edge device (e.g. TV, access point (AP), computer, etc.) in an ecosystem. The network edge device may have access to extra power sources, which may alleviate energy consumption and processing constraints on the client device.

In certain embodiments, device awareness systems and methods for ambient network sensing are provided. The systems and methods may include and complement existing device sensors (e.g. GPS, light sensors, etc.) to enhance one or more device performance metrics. The device performance metrics may relate to reducing power and/or energy consumption, enhancing data throughput, reducing service cost, etc. The systems and methods may be applicable to multi-mode or multi-standard mobile (or portable) devices that can connect to different wireless networks co-existing in a heterogeneous network environment. In certain embodiments, ecosystem-based systems and methods are provided that may significantly enhance the accuracy of the network sensing and the related VHO operation.

In certain embodiments, systems and methods may be based on a cross-layer optimization architecture that defines a fine grained device model and selects the optimal network connectivity for the existing application given user preferences and existing contextual information extracted from multiple layers. User experience may be maintained or enhanced during a VHO by seamlessly maintaining the application and session connectivity using the mobile device.

In certain embodiments, the mobile device may be included within an ecosystem with other devices, such as network edge devices. The network edge devices may, for example, cooperate with the mobile device to provide the seamless VHO. In an embodiment, a seamless VHO may include monitoring and collecting contextual information. The contextual information may include cross layer contextual information associated with an application, user preferences, radio frequency (RF) channel sensing, and neighboring device detection. The seamless VHO may include ecosystem communications, device and network state modeling, context management (e.g., metric computations), handoff prediction and network selection, and handoff execution and management.

### Ambient Network Sensing

Systems and methods are provided that relate to “ambient network sensing”. The term “ambient network sensing” is used herein to refer generally to a sensing system or method that enhances device context awareness for selection of an optimal (e.g., best or most favorable) available network for a current application and traffic pattern. In general, the context awareness may relate to the visibility of characteristics describing interactions of the current application running on a specific device with a specific RAN connectivity and service execution environments. In this way, for instance, management operations may adapt service provisioning to current device states and network conditions. In an embodiment, the context awareness may relate to full visibility of all characteristics describing interactions of the current application running on a specific device with a specific RAN connectivity and service execution environments.

In certain embodiments, systems and methods may assist devices to transition to a more resource efficient state by using the visibility of available wireless connections and their handoff characteristics that may lead to device performance enhancements. A “device state” may be determined (or defined) in a manner that accurately reflects one or more device metrics of interest. For example, the device metrics may include performance metrics, such as power, speed, delay, processor load, etc. In an embodiment, the device metric may include energy or power consumption, such as battery consumption. A RRC state machine may be a component of the device state. The RRC state machine may be an important component due to resource limitations in mobile computing platforms and the role of the RRC state machine in the device energy consumption. The RRC state machine may behave differently for different RANs. In certain embodiments, operator preferences, user preferences, or user behaviors may also be considered as other contextual information that may affect the context aware network selection.

Applications may run differently on different networks even if all other contexts unrelated to networks stay the same. For example, in mobile devices, application traffic patterns may trigger RRC state transitions which may consequently affect a device's radio resource consumption, battery usage, and user experience. A realistic modeling and awareness of RRC states and their transitions in relation to the application demands may enable a more accurate determination of device efficiency and energy usage.

In certain embodiments, network awareness may be based on efficient resource usage. Optimization challenges for mobile applications may be attributed to the limited resource availability in mobile devices creating a resource-oriented computing environment which naturally demands complex interactions with the application behavior. However, mobile application developers may be unaware of wireless interface specific characteristics and may not have visibility into such resource-oriented mobile execution environments. The lack of transparency in the lower layer protocol behavior, with respect to applications, may make some mobile applications unfriendly towards cellular or wireless technology, and may negatively affect the efficiency of radio channel utilization and device energy consumption.

In certain embodiments, systems and methods for ambient network sensing may select an optimal network for an application running at a specific time and location. In this way, the most resource efficient device connectivity choice may be provided given the current device and network conditions. A fine-grained cross-layer device-network connectivity state model may be provided to identify the interactions between layers. These layers may range from user input, user behavior, and application specifics down to the lower layers in the protocol stack, such as HTTP, transport, and RRC. In this way, a RAN that interacts optimally with the current application, given other cross-layer contextual information, may be selected.

The cross-layer information may include both device specific and network specific data to provide device optimization. The optimization may include various criteria. For example, in one embodiment, the optimization may include the device battery power optimization that maintains a QoS of an application that may be currently running on a client device. Multiple choices of network connectivity or radio access technology (RAT) PoAs may be searched to achieve an optimal choice that maximizes resource usage or minimizes the unnecessary overheads that may exist due to the lack of transparency in the lower layer behavior with respect to the application layer.

In certain embodiments, network awareness may be based on interference awareness. For example, real time RF monitoring may be implemented to enhance the accuracy and speed of the channel scanning required in ambient network sensing. A network model may be implemented with real time contextual information that may predict the device resource allocation changes due to existing interferences. In this way, the accuracy of network based context used in the radio resource enhancement process may be increased. In addition, interference awareness may significantly help with horizontal and vertical handoff by speeding up the RF monitoring phase (e.g., avoiding channels in an interface) required in a handoff process.

In certain embodiments, middleware constituting an intelligent client may be provided on the device side. The middleware may enable a client device (e.g., smartphone, tablet, etc.) to make intelligent network selection and traffic management decisions between available RAN technologies, such as Bluetooth, Wi-Fi, 3G, and LTE networks. In this way, the middleware may provide beyond what is provided by Access Network Discovery and Selection Function (ANDSF) and Hotspot 2.0 (HS2.0), for instance. The capabilities of these networking alternatives may be provided to the middleware in terms of “profiles”. Profiles may generally refer to a collection of handoff related parameters per network. The middleware may also provide other operator and service related support functionalities, such as intelligent management of application-specific traffic and operator use cases (e.g., Wi-Fi offload) while maintaining the QoS and quality of experience (QoE) for users on any network.

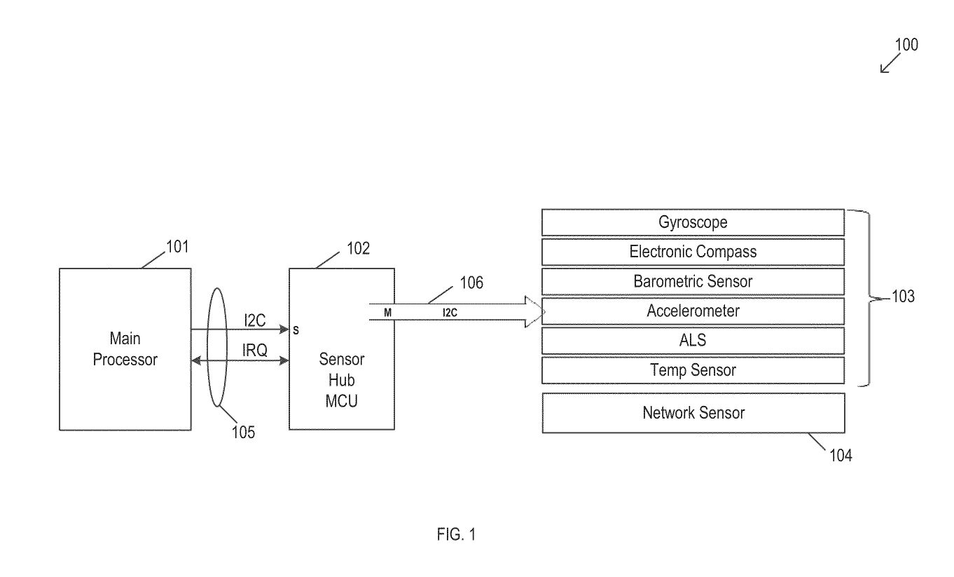

FIG. 1 illustrates a block diagram of an example ambient network sensing (ANS) system 100, according to certain embodiments. The ANS system 100 is shown including a processor 101, a microcontroller unit (MCU) 102, on-device sensors 103, and a network sensor 104. The ANS system 100 may be implemented on any of a variety of devices, such as mobile devices. The components illustrated are not intended to be limiting. It should be appreciated that other components of the device (e.g., operating system, speaker, microphone, input controls element, communication port, transceiver, memory, etc.) are not illustrated to avoid obscuring details of the present disclosure.

In the embodiment shown, the processor 101 may communicate with the MCU 102 via a communication bus 105, such as an I2C bus. The MCU 102 may communicate with the on-device sensors 103 and the network sensor 104 via a communication bus 106, such as an I2C bus. The network sensor 104 may provide ambient network sensing capabilities as described herein and may be considered a new sensory mechanism that adds to the device awareness. On-device sensor 103 may include traditional sensors, such as gyroscopes, motion detectors, light sensors, temperature sensors, etc. The network sensor 104 and the on-device sensors 103 may enrich awareness of context and environmental conditions. Such contextual information may range from a device's spatial and environmental contexts (e.g., motion, location, and orientation) to environmental information (e.g., light, temperature, and user to machine interactions such as touch and voice).

In certain embodiments, the ANS system 100 may perform ambient network sensing in an ecosystem. The ANS system 100 may detect multi-network diversity to optimize one or more device metrics, such as energy consumption. In an embodiment, the ANS system 100 may detect bandwidth availability and compensate for interference.

Systems and methods for handoff decision and execution based on context available to the device or network are provided. The systems and methods may collect contextual information and, based on the contextual information, a handoff decision may be made that includes when and where to trigger a handover. The “when” decision may refer to a time to make an optimal handover, while the “where” may refer to selecting the optimal network fulfilling various requirements for the switching. Example algorithms allowing evaluation of cross-layer multi-parameters may include techniques such as fuzzy logic, neural networks, pattern recognition, etc. A handoff execution may involve executing the handoff while maintaining (or guaranteeing) a smooth application session. Control signaling and the IP management protocols may be used in the handover, for instance.

Contextual information (or contexts) may be collected and pre-processed for incorporation into a network selection algorithm. In one embodiment, metrics and parameters of diverse components may be combined to build an optimal cross-layer handoff algorithm. For example, a decision mathematic algorithm may include a Markov decision process (MDP) with link reward and signaling overhead functions. Another embodiment may be based on a weighted Markov chain (WMC). In an embodiment, a Markovian solution may be based on rank aggregation. Other algorithms may be implemented in other embodiments.

In certain embodiments, access network selection may comprise parameter selection algorithms; parameter processing algorithms; or parameter aggregation algorithms. The parameter selection algorithms may utilize contextual information to generate information to perform an accurate decision. For example, any changes in context of the client device or the network may trigger events and processes which may be used to make a VHO decision. Depending on the number of parameters selected for processing, algorithms may range in complexity. In one embodiment, network services, user preferences, device specifications, and time may be considered. Once the information is collected, a QoS predictor may perform a path prediction to ensure end-to-end QoS. For example, the contextual information collected and predicted may be evaluated under an analytic hierarchy process (AHP) algorithm, in which the decision problem is divided into sub-problems. Other algorithms of the multiple criteria decision making family may also be implemented.

The functions used for parameter processing algorithms may vary from pure mathematical to computational algorithms. For example, an example parameter processing algorithm may be implemented using a Markov decision approach based on rank aggregation, where the top weighted network may be selected, or based on neural or fuzzy logic.

Parameter aggregation algorithms may be implemented to account for diverse metrics and parameters used to evaluate the most optimal candidate networks. For example, multiple criteria decision-making (MCDM) algorithms may be implemented to aggregate all the processed parameters. Examples algorithms may include, but are not limited to, grey relational analysis (GRA), technique for order preference by similarity to ideal solution (TOPSIS), and simple additive weighting (SAW). For instance, both GRA and TOPSIS may use an ideal solution for comparison and select the one nearest to the ideal solution. In another instance, a SAW may be implemented and based on scoring each alternative by adding the attributes weighted by their weights.

Contextual information may facilitate successful hand off execution. An accurate VHO, for instance, may take into account service continuity, network discovery, network selection, security, a device's energy-management and QoS issues. In some embodiments, certain contextual information may be considered more important or be primary factors (e.g., QoS) over others. For example, in a homogeneous network environment, deciding “when” to handover usually may depend on RSS values for instance, while the “where” may not be an issue since the same networking technology applies for a horizontal handover.

In certain embodiments, contextual information may be collected from different sources, such as both at the client device and at a network edge device. For example, a mobile device may directly survey the surrounding networks in order to discover services, data rates, energy, and power consumption. In one embodiment, this task may be transferred to a network edge device. The network edge device may include, for example, an access point (AP) or server. In some instances, to complement the information collected through scanning, networks may also advertise their supported services and QoS parameters while device information (e.g., speed, battery status, features, etc.) is collected. Contextual information concerning user preferences may also be used to determine a decision as to handover, which may be primarily due to its impact on the end-user's satisfaction.

In certain embodiments, middleware may perform context-aware handoff management to best suit a desired purpose. For example, a device-centric cost function may be optimized through execution of transparent handoffs while avoiding service interruptions. A more complete awareness of the environment, including the device state, and the handoff process may provide for more effective and efficient optimization of device performance and service continuity in heterogeneous environments.

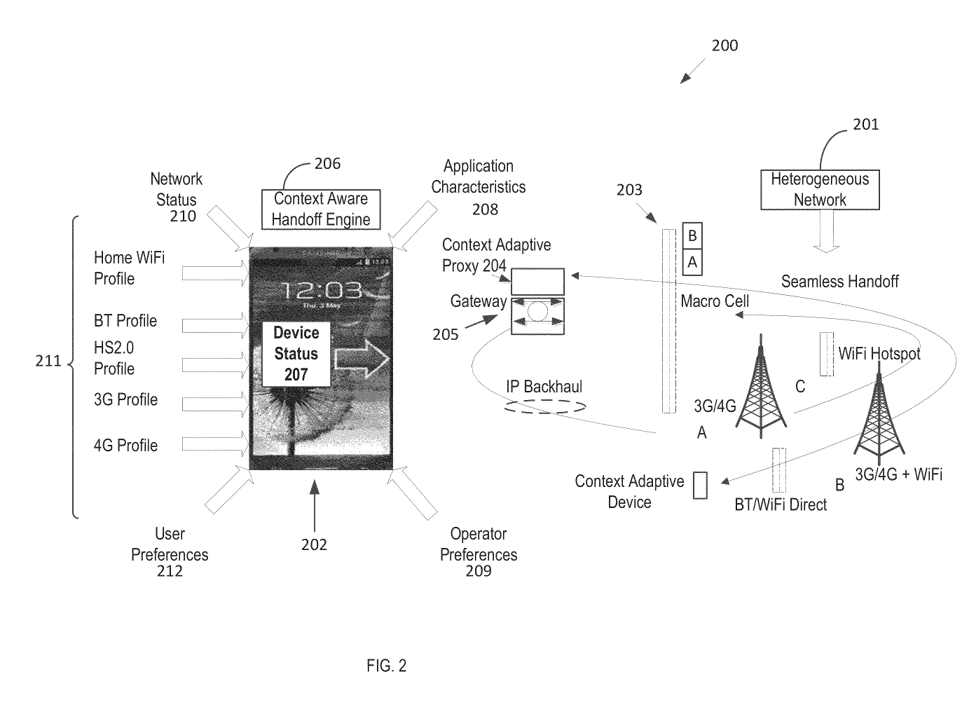

FIG. 2 illustrates an exemplary system 200 for performing a device-centric context-aware handoff, according to certain embodiments. The system 200 may include a heterogeneous network 201 and a client device 202, such as a mobile (or portable) device. Example client devices may include smartphones, tablets, laptops, etc. The heterogeneous network 201 may include a macro cell tower 203 which hosts a colocation of base station devices from two operators, A and B. Other small cell architectures supporting “3G/4G” and “3G/4G+Wi-Fi” may enhance capacity and coverage holes for operators A and B, respectively. In addition, a “Wi-Fi Hotspot” may be operated by a third operator C. A user home network capable of supporting WPAN connectivity with Bluetooth plus Wi-Fi direct may be situated within the footprint of the macro cells A and B. The example networks and configuration is not intended to be limiting. Many different combinations of alternative connectivity may be available to the user depending on location, device characteristics, and network conditions. In some instances, one or more connectivities may not be manageable by the operators A, B, or C.

The system 200 may also include middleware having two ends operating in a client-proxy setup. A context aware handoff engine (CAHE) module 206 may constitute the client residing on the client device 202, while a proxy 204 may be installed on the infrastructure side of the heterogeneous network 201. In an embodiment, the proxy 204 may be installed on a service gateway 205 acting at a session layer as a “session proxy”.

The client device 202 may be a context adaptive device equipped with the client 206 of the middleware. The client 206 may function as a context-aware handoff engine (or module). The term context-aware handoff engine may also be referred to herein as a “CAHE module” or “CAHE”. The task of the CAHE module may be to monitor handoff opportunities that may lead to a better “device state”, given current collected context information. The CAHE module may also have control over the ordinary handoff events, which may be triggered by user movements. The CAHE module may, for instance, be a decision function based on a weighted requirement and contextual information, such as maximum energy or power consumption, application, and user preferences. Implementing context-aware handoffs with service continuity management may involve many technological details extending across different layers affected by the underlying executing platform.

In certain embodiments, applications may only have to declare their service requirements to the middleware infrastructure, such as through session initiation protocol (SIP) or IP multimedia subsystem (IMS) signaling. In this way, the handoff process may be simplified. For example, the task of using the device states and context awareness may be performed only within the middleware. The middleware on the user device 202 and proxy 204 may take over the handoff responsibility as well as the specific management operations. Systems and methods are provided in the present disclosure for prediction and triggering of handoff events (e.g., handoff awareness), management of service quality requirements and handoff-related quality degradations (e.g., QoS awareness), and solutions for visibility into network topology and local resource availability (e.g., location awareness).

Example categories of contextual information shown in FIG. 2 may include device level contextual information (e.g., device status 207), application level contextual information (e.g., application characteristics 208), network level contextual information (e.g., operator preferences 209, network status 210, and RAT profiles 211), and user level contextual information (e.g., user preferences 212). The CAHE module may include a device state and handoff recommendation module which may process the contextual information to optimize the device state based on available networks where an existing session may be run.

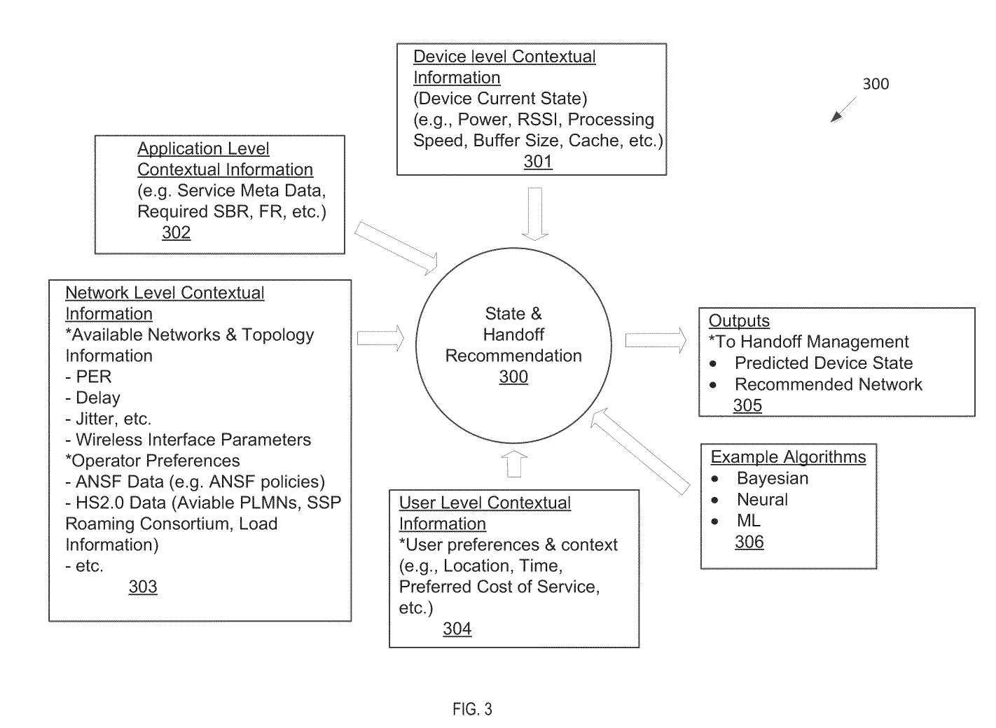

FIG. 3 illustrates a diagram of an exemplary device state and handoff recommendation module 300, according to certain embodiments. The device state and handoff recommendation module 300 is shown including device level contextual information 301, application level contextual information 302, network level contextual information 303, and user level contextual information 304. The device level contextual information 301 may include contextual information related to the current device state (e.g., estimated according to a state definition model), data such as a received signal strength indicator (RSSI) for a current link, etc. Both the static (fixed) and dynamic (variable) nature may be considered. Example static device contextual information may include graphics, sensors, interfaces, RAM, display size, etc. Example dynamic device contexts may include measured data such as RSSI, interference reports, default network, historic power and energy usage profiles, etc. The application level contextual information 302 may include contextual information collected by different alternative signaling mechanisms, such as application level metadata, QoS parameters (e.g., a required sender bit rate (SBR) or frame rates), etc. The network level contextual information 303 may include available networks and their supported profiles; QoS parameters such as delay, jitter, and bit error rate (BER); and operator preferences communicated through operator signaling such as the ANDSF and HS2.0. The user level contextual information 304 may include static or dynamic characteristics. The user level contextual data 304 may include a user preferred network, a user location, a user state (e.g., awake, sleep, etc.), user feedback on the QoE, etc. The device state and handoff recommendation module 300 may process the contextual data inputs 301,302,303,304 using an algorithm 306 (e.g., Bayesian, Neural, ML, etc.). The device state and handoff recommendation module 300 may provide output 305, which may include a predicted device state and recommended network. It should be appreciated that the contextual information shown is exemplary and not intended to be limiting. In other embodiments, for example, one or more of the types of contextual information shown in FIG. 3 may not be included, or additional contextual information not shown in FIG. 3 may also be included.

### Network Monitoring and Contextual Information Collection

In an embodiment, access network monitoring and contextual information collection may provide more complete environment awareness, including device state, for the handoff process. Such awareness may be used to achieve more effective and efficient optimization of device performance and service continuity in heterogeneous environments. Access network discovery may involve identifying different available wireless networks before switching from one RAT to another. Access network discovery may be performed in an energy-efficient way, such as described herein, to accommodate device centric and energy efficient constraints.

In certain embodiments, contextual information may be used in order to identify available point of attachments (PoAs). Contextual information such as time, history, wireless network conditions, device location and motion may be determined and used to estimate network conditions without powering up the wireless network interface cards (WNICs). For example, in an embodiment, network conditions may be estimated based on usage and time, such as time of day. For instance, network conditions at the same time on different days may be statistically inter-related. In an embodiment, network conditions may be estimated based on historical data. For instance, historical data may relate to network conditions collected during previous connections until a new measurement opportunity occurs, or until a defined time period has elapsed.

In an embodiment, network conditions may be estimated based on base station data. For example, base station data may include visible cellular tower information that is available to the client device and which can be used to exploit the correlation between the network conditions and geography. In some instances, GPS may be excluded due to its high energy consumption. In an embodiment, base station data may include cell identification (ID). For instance, availability of RATs (e.g. Wi-Fi, Bluetooth, etc.) may be calculated as a weighted sum probability calculated per RAT when each cell tower is visible. In an embodiment, the base station data may include fingerprinting data. For example, an ordered set of a multitude of visible cell towers reported by the client device may be used as contextual information to provide accurate results. In some instances, memory and prior training at each location may be implemented.

In an embodiment, network conditions may be estimated based on trigger based measurements. For example, specific events may be triggered by a client device and its motion, such as device acceleration. These events may be used to measure how much a client device (or user equipment (UE)) has moved. In an embodiment, if the movement is above a certain threshold, a new measurement may be performed. Otherwise, previous network conditions measurements may be used.

In an embodiment, network conditions may be estimated based on a RAT. For instance, one RAT may be used to estimate or to control another RAT's connectivity. In an embodiment, a RAT may be used for coverage estimation of another RAT. For example, a Wi-Fi interface activation process may be controlled by monitoring the 3G or 4G cellular signal quality. In this regard, Wi-Fi signal degradation when moving from indoors to outdoors may be used to design an algorithm to estimate WLAN coverage area. In an embodiment, RAT information may be used to connect another RAT. For example, to avoid an energy consuming process of turning on the Wi-Fi during a network discovery and association, the UE may access location based information through cellular paging channels and may directly associate with a PoA.

In an embodiment, a RAT may be used to wake up another RAT. For example, a Wi-Fi interface may be turned off after an inactivity timer has expired. A paging signal may be initiated through a cellular network (e.g. 3G) to wake up the Wi-Fi WNIC when there is data to be sent or received. This feature may also be applied to other short range indoor wireless connectivity choices (e.g. Bluetooth, Wi-Fi Direct, etc.) as a second lower-power radio with a wake-up channel for the main radio (e.g. Wi-Fi, cellular, etc.) in order to save power and/or energy.

It should be appreciated that in other embodiments, a hybrid method may be implemented. For example, combinations of different estimation methods may be used in an algorithm which is event driven to save the battery life.

### Ecosystem-Based, Energy Aware Context Collection

In certain embodiments, systems and methods may be provided for a VHO process that incorporates an ecosystem involving both client devices (e.g., mobile devices) and network edge devices. The ecosystem may serve as a loosely-coupled VHO platform. In certain embodiments, some or all energy consuming tasks of network monitoring may be transferred to another device (e.g., a network edge device) in an ecosystem. The network edge device may be, for instance, a fixed device at the edge of network that has both wireless and wired connectivity capabilities. Support from the network edge device may enrich the awareness of smart and ambient-aware client devices. Such client devices are capable of monitoring their ambient environment, adapting their operating parameters in response to incoming RF information, and establishing an energy-aware VHO execution while being aware of their internal state transitions and past observations.

In certain embodiments, modeling and monitoring may be performed for effective and efficient contextual information collection. In a home or enterprise networking environment, a client device may be any of a variety of devices, such as mobile devices including cellphones, tablets, another smart portable terminal, etc. The network edge device may be any of a variety of devices, such as a special multi-homed AP, a smart TV, a computer (e.g., laptop or PC) with multiple wireless RAT capabilities, etc.

The coordination of devices at the network edge in an ecosystem structure may enable various monitoring tasks. For example, the monitoring tasks may include RF analysis and passive scanning. A scanner or network monitoring device may “listen” to capture network and interference activities within the radio bands of interest. Frequency and time domain based scanning may be performed. For instance, the frequency based scanning may be used to determine network activities in a band of interest and to detect interfering energies. Once interference is detected, time-based scanning may help characterize the interference source and its behavior to make a more energy and time efficient channel. In this way, smart scanning may be provided. Analog and digital beam forming may also be used to locate sources of interference, as well as to furnish a better link budget for interference measurement device. As a result, measurement accuracy may be improved.

The RF analysis, which may be performed in a network edge device in some embodiments, may be software based or hardware based. The RF analysis may be based on different protocol layers involved. In certain embodiments, the RF analysis may be software based and include monitoring within the layer 1 protocol layer. For example, the RF spectrum may be scanned to detect and classify unwanted sources of interference. The scan data may be processed to establish a real time visual interference classification map of existing energy at different frequency bands. The map may cover multiple RATs of interest as captured by a scanner. Moreover, interference classification may also be performed by a remote server or appliance on the backbone, such as by transmitting the raw spectral data captured by WNICs in a network device, such as an AP, and forwarded by a network CPU. The interference classification may also be performed by a network CPU within a network edge device that sends consolidated spectrum data and interference event notifications across the network to the remote server or appliance. The server may then analyze the raw data to classify the source of the interference and its severity on the radio channels of interest. In some instances, this may be fast and scalable as it may not introduce excessive traffic to the wired infrastructure.

In certain embodiments, the RF analysis may be hardware based (e.g., chip based) and include monitoring within layer 1 protocol layer. For example, the hardware based implementation may benefit real time monitoring, fast detection, and fast analysis of interference or security threats. The hardware based implementation may help with very accurate classification of unknown or unexpected interference sources through both time domain and frequency domain analysis. In addition, when a chip may be dedicated to RF monitoring, its integration into a network device may provide simultaneous monitoring and WNIC operations that may quantify the effect of interference on network performance. This may be beneficial to both the computation of performance and energy burdens of a current channel, as well as to the cost of switching to a specific radio. Advanced interference monitoring and management may be achieved while requiring almost no resources from the network device (e.g., CPU and memory), RAN, or a remote server.

In certain embodiments, the RF analysis may be based on monitoring including layer 2 or above protocol layers. In an embodiment, data packets may be captured and dumped for analysis. For example, to enable capture of parameters of interest, a sniffer may be implemented to establish a “raw virtual platform”. For instance, in a network monitor (Net Mon) operation mode, a Wi-Fi WNIC may act as an 802.11 station that monitors a communication channel by evaluating packets that are sent over WLAN media by other devices. This may be used, for example, to discover how many Wi-Fi devices are already using a spectrum in a given area and to discover how busy various Wi-Fi channels are in that area. A Wi-Fi packet sniffer such as Kismet, Wireshark, etc., may be used to enable capture of all packets received on a raw virtual interface. A layer 2 network sniffer and intrusion detector that operates on raw monitoring mode of the Wi-Fi WNIC device may be used to help with analysis while being capable of detecting hidden networks that do not broadcast SSID. In one embodiment, the sniffer implemented is Kismet. Kismit may also detect other non-Wi-Fi networks such as Bluetooth, DUCT, etc. The sniffer may then “log” all sniffed packets and save them in a “dump” file. Kismet may also capture PPI headers and may support logging of geographical location of a network if APIs for GPS transceivers or other location mechanisms are available. Sniffers such as Kismet may also measure signal and noise level, and may also observe network management traffic.

Passive monitoring may include collecting contextual information that may be factored into a handoff decision. For example, in Wi-Fi, each received frame (e.g., from APs) may be annotated with an index for a current beam pattern on an antenna, location information, a current channel, a PHY-layer data rate, a signal-to-noise ratio (SNR), etc. In an embodiment, the SNR, data rate, or channel information for each received frame may be obtained from a radio-tap header appended by a driver for each received frame. The entire frame with the annotated information may be logged during a scan and may be considered as an RF signature, for instance.

In certain embodiments, active scanning may be performed. In addition to listening, the active scanning may include interacting with different devices for collection of contextual information. Such scanning may aid a handoff decision. In one embodiment, Wi-Fi and 802.11k protocols may be implemented to extract information about a client device environment to make a better handoff decision. Communication may be directly established by a network edge device with client devices (or UEs) that support the protocol. The received frame (e.g., from client devices) may contain interference information and may be annotated with a number of additional information. The annotations may include additional information, such as: an index for a current beam pattern on an antenna; location information; a current channel; a PHY-layer data rate; a SNR; a number of APs within range of the station on either a specified channel or on all channels; a level of WLAN activity on each channel; a non-WLAN radio activity on each channel; a strength of the beacon signal from each AP; statistics (e.g., average delay, number of FCS errors, number of failed transmissions, etc.); a location of stations; etc.

### Context Collection and Analysis

In certain embodiments, cross-layer contextual information may be used to enhance the effectiveness of context-awareness in ambient network sensing. By accurately and efficiently exposing cross-layer interactions across various layers, inefficient resource usage for smartphone applications may be detected. As indicated above, cross-layer contextual information may comprise information or parameters from two or more OSI layers. For example, the cross-layer interactions may include interactions with a user interaction layer, an application layer, a transport layer, and a RRC channel state. Direct access to a RRC engine or accurate inference of lower-layer RRC states may enable interactions with the RRC channel state. Quantifying the impact of service and application traffic patterns on the energy consumption may be driven by a RRC state machine.

Cross-layer contextual information may be jointly analyzed to accurately detect energy and radio resource consumption and to select a most efficient network in ambient network sensing. The RRC state module (or engine) may be transparent to higher layers. Such cross-layer contextual information collection may be extended to both device and network related information in an ecosystem. Selection of the optimal network for handoff may be benefited by consideration of true tradeoffs between important parameters such as QoS and energy consumption. The analysis may include selecting a most application friendly network for given cross-layer contextual information. In particular, multiple analyses may be performed for RRC, HTTP layer, TCP layer, user interactions, and application interactions and their cross layer interactions. The analyses may be used to detect a more accurate impact of smart phone applications on radio resources and battery life of a client device.

Many applications may be mobile device unfriendly. For instance, professional developers may not have adequate visibility into a resource-constrained mobile execution environment. This lack of transparency in the lower layer protocol behavior may result in inefficient radio channel utilization or device energy consumption. By exposing cross-layer interactions of lower layers (e.g., RRC, HTTP, transport) up to higher layers (e.g., application, user input, user behavior), the performance of an application and its service pattern as related to a specific RAT may be determined and a most efficient connectivity choice may be selected. This may include collecting device specific contextual information and network specific contextual information within the ecosystem. In an embodiment, a factor in estimating the application performance and network energy efficiency may be the determination of the effect of application traffic patterns on RRC states and transitions among RRC states. In mobile computing environments, the RRC states may be used to efficiently utilize limited radio resources and to improve a client device's battery life. More specifically, application traffic patterns may directly trigger RRC state transitions, which may affect the client device's radio resource utilization, its overall energy consumption, and user experience. As such, accurate information regarding the RRC states and their transitions may be beneficial for selection of the most energy efficient network.

In certain embodiments, data collection and offline processing may be performed by fixed or portable devices at the network edge in support of the analysis of cross-layer contextual information. For example, for each available RAT, an application profile may be established through activation of a data collection agent. The data collection agent may be tasked to collect packet data by running a sample application for a desired duration as a normal application user. The data collection agent may capture packet traces, as well as system and user input events, which may be subsequently processed by an analysis module on a CPU of a network edge device. In an embodiment, the ecosystem based processing may include an inference of the RRC states per RAT using simulation based approaches.

Network connectivity may affect energy consumption. Traffic patterns may impact radio power management policies and the RRC states. In certain embodiments, a high granularity (e.g., burst level) resource consumption analysis may be implemented, which may include defining resource consumption of a traffic burst and related triggering factors. A factor that may be used in a model may be, for instance, the fine grain determination of the engagement of system resources for each type of application or traffic per network. In one embodiment, a system call based metric that specifies a certain amount of workload may be used. For example, sending X bytes to a WNIC may send a component (e.g., CPU and memory) into one of several possible base power states. Sending a few packets within a short period may send the WNIC to a lower power base state, while sending many packets (e.g., via one or multiple back-to-back send system calls) may send the WNIC to a high power base state. The model may account for environmental factors (e.g., interference level, noise, co-channel interference, adjacent channel interference, channel air quality, etc.) that may be collected in home (or indoor) environments through spectral sensing in a network monitoring module that may be in either, or both, mobile devices and fixed devices within an ecosystem. In this way, the local connectivity power states may be established in a relatively real time manner. The network monitoring module may regularly provide a list of available networks both in terms of offered QoS and energy consumption factors, which may be established via autonomous network sensing or through 802.21 servers in conjunction with the ecosystem information.

An energy profile for a client device may be designed (or determined) and used with ambient network sensing. In some instances, a direct RRC measurement may be performed. A data analysis module, for instance, may be able to read the RRC states directly from the client device. For example, the data analysis module may observe low-level communication between the client device and the network. This may require access to APIs that can provide the RRC state information. The RRC state machine may be configured differently in different operator networks, so in some instances a predefined state machine may not be sufficient. In the absence of direct measurements, RRC tales may be inferred by inference techniques for the RRC state machines of different RATs. The inference techniques may be necessary in some instances due to lacking of an interface for accessing the RRC states directly from the client device hardware. For example, some of these techniques may accurately infer RRC states from packet traces that are collected and post processed. In an embodiment, simulations may be used to infer the RRC states by estimating different energy levels of the RRC states. Collection and processing of data packet traces may occur at a cellular core network or at a mobile handset, for instance. Simulations for different applications may then provide the expected energy consumption for specific traffic partners. In other embodiments, an average energy consumption per WNIC may be considered as a network selection criterion. For example, approaches based on using average power consumption values for each of the RRC states from a particular interface card may be considered. The energy consumption rates of typical 3G and Wi-Fi cards may be used to estimate a client device's energy consumption. The estimation may provide a general idea of major differences between energy consumption when using different RATs. Estimating actual power consumption may depend on many factors.

In certain embodiments, RRC inference techniques for each RAT may be implemented based on network dependent RRC parameters. This may occur, for instance, prior to the actual energy estimation. Based on the RRC inference, network-specific RRC parameters may be measured. These parameters may vary between different RATs. Example parameters may include, but are not limited to, inactivity timers, state promotion delays, RLC buffer thresholds, association times, tail states, short/long discontinues receiver (DRX) states in LTE, etc. For example, inactivity timers may be used to demote a communication link to active mode. The state promotion delay may be a promoting state which represents a time required for signaling a network to assign proper resources to a client device. This may be triggered, for instance, when a connection request is arrived during an idle state. The RLC buffer thresholds may define an onset of a state transition between a high power dedicate channel (DCH) and a medium power forward access channel (FACH). The association time may be important for LTE or Wi-Fi technologies. For instance, the association time may represent a time that a client device is looking for an available AP to connect to, such as evolved Node B (eNB) in a LTE network. Other network technologies may apply in other embodiments, such as a base station subsystem (BSS) in a GSM network. When a connection has terminated, the client device may enter in a connected tail state. When no connection request has arrived after a connected tail timeout, the client device may move to a short DRX state. After a certain timeout, the client device may move to a long DRX state.

Inferences of energy consumption may be based on modeling interactions of traffic patterns of an application with an RRC. In certain embodiments, actual power measurements may be performed on a client device (e.g., using power meters) to extract RRC state machine parameters. The actual energy consumption during an application session may be computed by simulation. In order to accurately estimate energy consumption per RAT and for a specific application, an iterative packet-driven simulation may be implemented. For example, a state inference algorithm may take all packets of a collected trace and apply them one by one to a state predictor simulator. The simulator may require parameters such as packet sizes, inter-packet arrival times, or a direction of each packet (e.g., uplink vs. downlink). The simulator may use this information to estimate a state at any time “t”. The energy consumption for any specific time period may be estimated through integration.

In certain embodiments, approximate modeling may be based on measurement and linear power functions. Actual power measurements may be performed on a client device to extract RRC state machine parameters. The actual energy consumption of each interface may be dynamically calculated based on an amount of data transfer or on a time the interface is being used. The energy estimation may be performed by modeling as a function of traffic pattern and data size. This may include, for instance, a linear function of these parameters with function coefficients inferred through measurement. For example, the energy consumption of typical wireless communication technologies found in mobile phones or tablets (e.g., Bluetooth, 3G, 4G, and Wi-Fi) may be performed by making use of an application (e.g., Android application) that sends and receives data continuously. The application may also monitor a client device's battery status so that an approximate energy model for each technology may be established. This model may behave close to a linear function that is capable of predicting a percentage of battery consumed for a series of states for a given interface technology. The percentage may be calculated, for instance, by estimating the amount of data transferred in gigabytes over an elapsed time of a transmission. These times may be considered as functions of application traffic patterns and user behavior.

### Energy Modeling

When real time direct access to RRC states is not available, embodiments may vary based on system requirements and accuracy of ambient network sensing. In certain embodiments, RAN diversity may be used to provide better device performance based on one or more device performance metrics. Contextual information may be collected to perform an energy aware VHO. In an embodiment, energy modeling may not require completely accurate energy consumption modeling, but rather, may provide sufficient accuracy to perform a HO. Characterization may be related to interactions of application patterns with a WNIC's RRC state machine. For instance, the overall energy consumption of a client device may be highly correlated to stopover times per interface RRC state, as each application and service can be characterized by different WNIC RRC state sojourn times. This stopover behavior may be used to directly determine different energy-profiles per service.

Various parameters may influence the robustness and the efficiency of a VHO. One example parameter may include a signal to interference plus noise ratio (SINR) level at a client device. Another example parameter may be network congestion or network load at the PoA side. However, many other parameters may contribute to selection of an optimal network for handoff, such as supported QoS on a target PoA, energy and performance cost of a specific VHO, signaling overhead, cost of connectivity and charging policy, and user preferences. A device's overall energy consumption, which is related to many statically and dynamically changing parameters, may be determined (or estimated) for energy efficiency purposes in a VHO. Example parameters may include supported RATs, a specification of WNIC defined by interface manufacture, a distance between a client device and a target PoA, an underlying mobile computing platform and an operating system (OS), a RRC state machine per WNIC and its network configuration, current communication state (e.g., Tx, RX, Idle, DRX, Tail, etc.), and current traffic pattern characteristics. In certain embodiments, dynamic parameters may be incorporated into a handoff decision. In some instances, the use of fixed energy consumption values in an RRC, without considering other energy related parameters and interaction of the application with the RRC state machine, may cause significant degradation of the overall VHO performance.

In certain embodiments, a VHO middleware-based platform within an ecosystem setup may include modules for invitation, decision, and execution of a VHO. These modules may optimize a device-centric cost function through execution of transparent handoffs while avoiding service interruptions. In an embodiment, full awareness of the environment including the device state and handoff process may enable effective and efficient optimization of device performance and service continuity in heterogeneous environments.

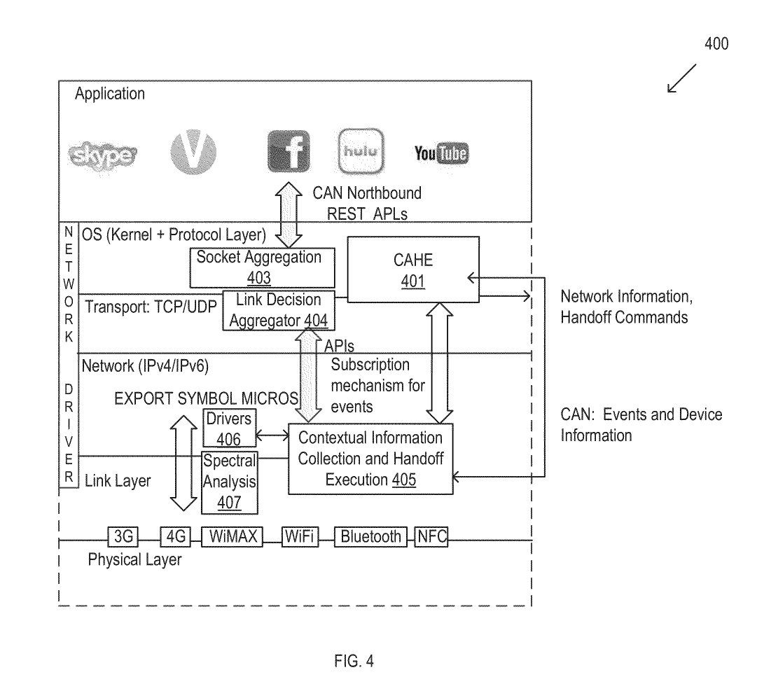

FIG. 4 illustrates an example block diagram of a high level architecture of a system 400 for ambient network sensing system, according to certain embodiments. The system 400 includes a middleware platform that is shown with respect to a protocol stack. The system 400 includes a context aware handoff engine (CAHE) module 401 that provides handoff decision and management capabilities in a manner that is seamless, QoS and QoE aware, and with complete context transfer and service rebind.

A socket aggregation module 403 and a link decision aggregator module 404 may operate in the upper layers with the CAHE module 401. Communication with a contextual information collection and handoff execution module 405 may be enabled through APIs. The handoff execution may be MIH function based. The contextual information collection and handoff execution module (or modules) 405 may be implemented as two separate modules in other embodiments. The contextual information collection and handoff execution module 405 may operate in the lower layers, such as the data link layer and the network layer, in conjunction with drivers 406 and a spectral analysis module 407. The CAHE module 401 may receive network information, events, and device information from the contextual information collection and handoff execution module 405 while providing the contextual information collection and handoff execution module 405 with handoff commands.

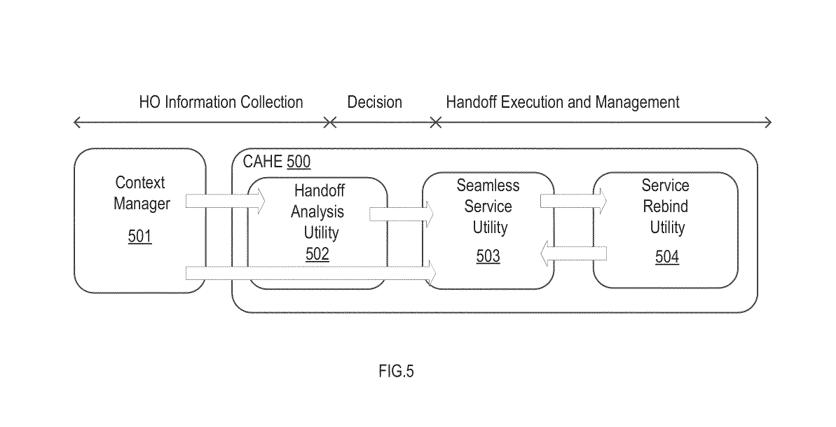

FIG. 5 illustrates an example block diagram of a CAHE module 500 and a context manager (CM) module 501, according to certain embodiments. The CAHE 500 and the CM module 501 perform various functions for contextual information collection process, decision process, and the handoff execution and management process. The CM module 501 provides functions for the handoff information collection process. For example, the CM module 501 may manage and provide device and network contextual information gathering for CAHE utilities. The contextual information collection may implement, for example, the 802.21 protocol and MIHF as described in the 802.21 standards.

The CAHE module 500 may provide functions for contextual information collection process, decision process, and handoff execution and management process. The CAHE module 500 may include a handoff analysis utility module 502, a seamless service utility module 503, and a service rebind utility module 504. The handoff analysis utility module 502 may perform handoff analysis and predication via full visibility into the contextual information, as well as, handoff procedures and parameters. This may involve for example, monitoring technology dependent handoff processes at a data link layer. The seamless service utility module 503 may perform an effective handoff management strategy to ensure compliance with application level and user service requirements through control of flow provisioning to combat handoff impairment effects. The service rebind utility module 504 may perform dynamic reconnection of clients to resources and service components at a target RAN. This may require an ability to move handoff context for client reconfiguration operation (e.g., client readdressing, AAA, QoS, location, etc.) and reconnecting all client components to locally available resources.

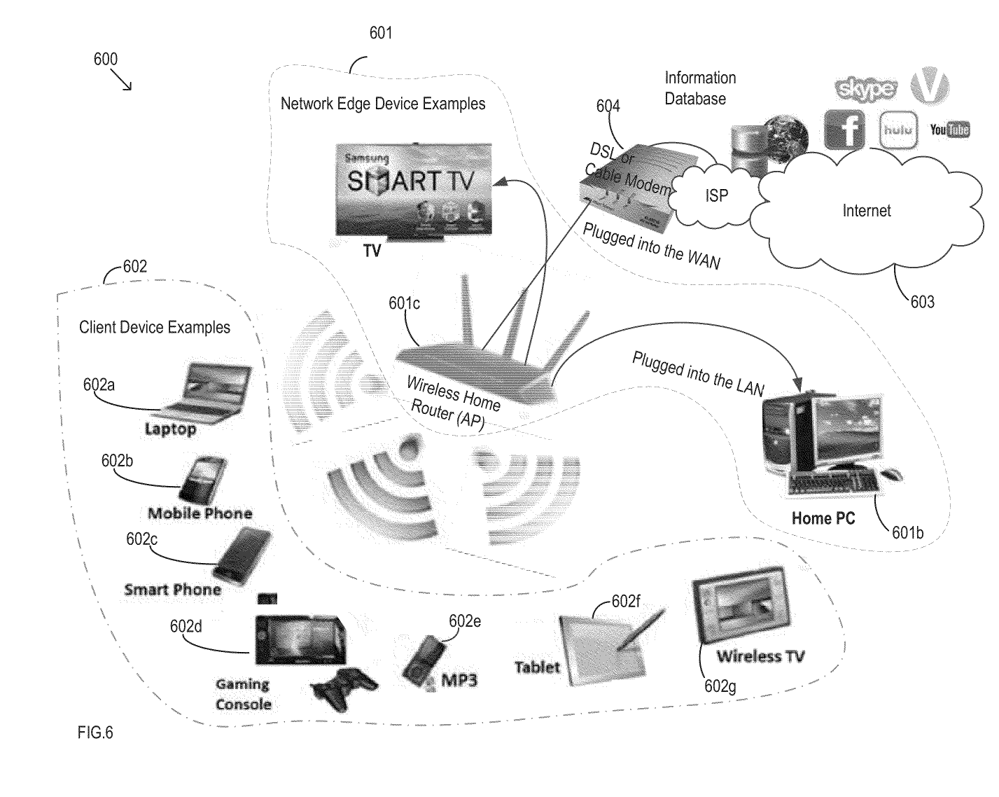

FIG. 6 illustrates an example ecosystem 600, according to certain embodiments. The ecosystem 600 is shown as an example home networking environment including various example components. The type of environment and components shown are not intended to be limiting, but rather are provided for exemplary purposes.

Ecosystem 600 is shown including network edge devices 601 and client devices (e.g., mobile or portable device) 602. The network edge devices 601 may be generally “fixed” devices that directly or indirectly connect to a network infrastructure 603. The connection to the network infrastructure 603 may typically be through a wired connection, but may in some instances be through a wireless connection. The network edge devices 601 may be connected to the network infrastructure 603 via a modem 604, such as a DSL or cable modem. Example network edge devices 601 may include a TV 601a (e.g., smart TV) and a computer 601b (e.g., PC). The network edge devices 601 may also include a router 601c (e.g., wireless router) that connects to the network infrastructure, such as via a DSL or cable modem. The router 601c may be a wireless router that provides a wireless connection to other devices in the home networking environment, such as mobile devices 602. Example mobile devices 602 may include a laptop 602a, a mobile phone 602b, a smart phone 602c, a gaming console 602d, mp3 player 602e, tablet 602f, and wireless TV 602g.

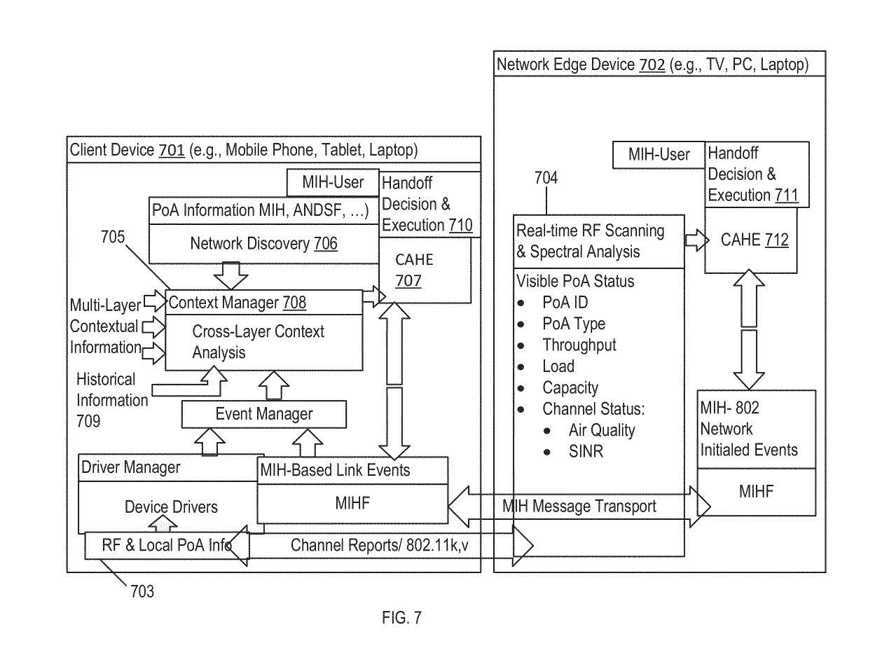

FIG. 7 illustrates a block diagram of an exemplary partitioning of context collection, analysis, and management mechanisms between a client device 701 and a network edge device 702, according to certain embodiments. The client device 701 and the network edge device 702 are shown and may communicate with one another to provide context management and analysis within an ecosystem. Device energy savings may be provided from smart scanning and from using RRC state machine. For example, smart scanning may minimize the required time for scanning through the ecosystem. Smart scanning may enable the identification of visible PoAs and channel quality. The RRC state machine may be used to select the most energy efficient PoA for current traffic.

The client device 701 and the network edge device 702 may include modules that perform real time monitoring of the network information. For example, the client device 701 may include a RF and local PoA information module 703. The network edge device 702 may include a real time RF scanning and spectral analysis module 704. In certain embodiments, in order to minimize the energy consumption in the battery operated client device 701, a major part of the real time monitoring may be performed in the network edge device 702.

Various levels of monitoring and modeling may be implemented in different embodiments. In certain embodiments, the real time RF scanning and spectral analysis module 704 may perform spectral monitoring and analysis, which may be implemented as a layer 1 software based or chip based RF scanning. When the scanning is passive, it may not require an active link with the network edge device 702 and may be performed in the background for all available RATs and their frequency bands. The outcome of this scanning may significantly reduce network monitoring time and energy consumption of the client device 701 since it may eliminate the scanning of channels which have weak air quality (bad SINR) due to interference or other effects.

In an embodiment, the spectral analysis may be performed based on active scanning. For example, the network edge device 702 may interact with the client device 701 and inquire about the channel quality from that perspective using 802.11k protocol for instance. The real time RF scanning and spectral analysis module 704 may also collect information about PoAs that the network edge device 702 has access to (e.g., through Wi-Fi and Bluetooth) and communicate this information to the client device 701 either through MIH management messages, wireless network management protocols defined in 802.11k (or 802.11v), or other message communication protocol.

Real time monitoring may be performed by the client device 701. The client device status raw information may be calculated based on data from the network edge device 702, or directly derived by looking into information residing in various protocol stack layers. For example, a current channel state and transmission profile adopted by a current device connection may be obtained by incorporating physical layer information while other parameters, such as the current interface state (e.g., transmit, receive, idle, DRX, etc.) and the current PoA information, may be acquired by MAC layer information. Having such cross-layer contextual information may significantly enhance the device's ambient awareness which may help with energy-efficiency. Other contextual information about the network connection of the client device 701 may include energy consumption monitoring parameters such as power consumption, current draw from the battery, cumulative energy consumption of the client device 701, etc. These parameters may, for instance, be provided in existing mobile phone software development kits (SDKs), or by modification to the SDKs.

The network discovery module 706 may perform monitoring to discover networks. Network discovery may be responsible for providing a CAHE module 707 with an up-to-date list of all device reachable and accessible PoAs. In an embodiment, this list may be obtained via autonomous network edge device 702 (or client device 701) sensing. In an embodiment, the list may be obtained by incorporating network side information, such as 802.21 Media Independent Information Services (MIIS) or from the Access Network Discovery and Selection Function (ANDSF) information provided by an operator. The network edge device 702 may also include a CAHE module 712.

A context manager (CM) module 705 may build and analyze power related contextual information that is collected and derived by the client device 701. This contextual information may include, for instance, device specific energy consumption values per WINO state. The contextual information may also include energy-profile and residual PoA utilization times for various service types and other parameters such as delay, throughput, and energy overheads introduced during past VHO execution phases, which are shown as historical information 709 in FIG. 7. The historical information 709 may provide processed contextual information for a VHO decision module from both energy consumption perspective and a QoS guarantee, in order to ensure proper inference of a QoS penalty, if any, of the VHO. This information may be used for appropriate adjustment of service provisioning to ensure support of QoS. The client device 701 may include a handoff decision and execution module 710 that may serve to decide and execute handoffs. The network edge device 702 may also include a handoff decision and execution module 711.

Device energy may be estimated for the handoff decision process. In certain embodiments, a hybrid approach may be implemented that accurately estimates an overall energy consumption of the device per WNIC interface and existing application traffic pattern.

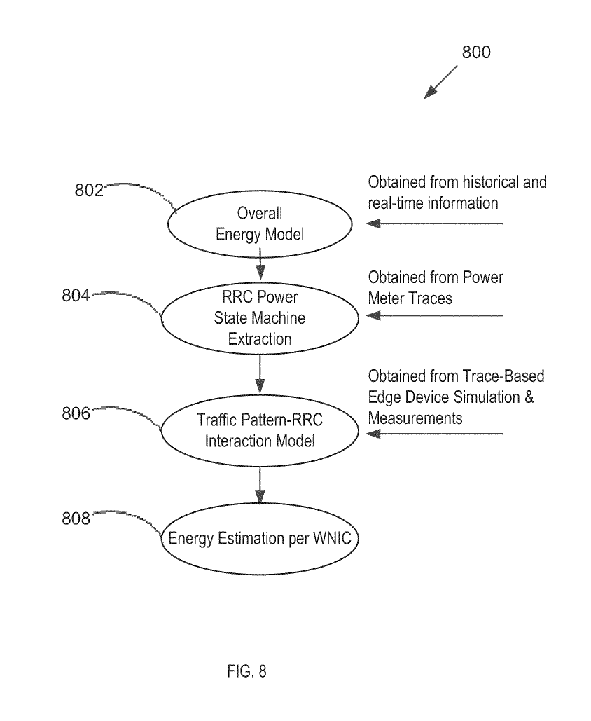

FIG. 8 illustrates a flowchart for an example method 800 of estimating energy for ambient network sensing, according to certain embodiments. At step 802 of the method 800, an overall energy consumption model is generated. The overall energy model may be a per device model that is based on sensitivity of a handover decision. Historical and real time information may be collected and used for the overall energy model.

At step 804, network and RRC state machine parameters may be extracted from existing networks. For example, actual power measurements may be performed on a client device (e.g., using power meters) to extract the RRC state machine parameters. Other network parameters such as beacon intervals may be captured during this time. At step 806, a model of traffic pattern interaction with the wireless network may be generated. The model may be generated through trace collection and trace-based simulation and measurements at a network edge. At step 808, energy per WNIC is estimated based on steps 804, 806, and 808.

The particular characteristics of each client device (or UE) may significantly affect the power consumption of the client device. These characteristics and their effect on power consumption may be factored into an energy model used in a VHO decision. In an embodiment, an energy consumption of an application in a device may be generally determined as a function of a load that is introduced on a mobile computing environment. In an embodiment, an overall energy, Total Energy, may be determined as a function of energy per different components according to the following example equation.

Total Energy=f(BW_{App},E_{Comm},E_{HO},E_{RAM},E_{RAM},E_{data},E_{Comp},E_{screen},BW_{Buff},QOS_{App},E_{GPU},E_{Audio},E_{CAM}, . . . )

BW_{App} may represent the application data consumption rate on buffer. E_{Comm}, E_{HO}, E_{RAM}, E_{RAM}, E_{data}, E_{Comp}, and E_{screen} may represent the energy costs of communication, handoff, storage, data message size, computation, and touchscreen use (e.g., particularly the back light), respectively. BW_{Buff} may represent the I/O buffer bandwidths. QoS_{App} may represent the application QoS requirements. E_{GPU} may represent the energy used by the graphics hardware. E_{Audio} may represent the energy used by the audio codec, amplifier, or other audio related device. E_{CAM} may represent the energy used by the camera system. In an embodiment, the total energy consumption may be based on the sum of each energy component. Some of these parameters may be obtained from historical and real time information when device APIs are available. The accurate evaluation of an overall absolute energy may not be required to select the best network which minimizes the overall energy consumption while maintaining the QoS. In an embodiment, only the more relevant energy consuming components may be highlighted or emphasized, while parameters that have minute or insignificant roles in overall energy consumption may be eliminated or deemphasized. This may result in a more simplified model.

To explore potential energy savings by means of VHOs, certain embodiments may consider selection of an optimal access network. This may be assessed from a network connectivity perspective, given accurate information about a network load and future demand from applications running in the client device. A single model may not necessarily be used for different client devices due to significant differences in their hardware and software architectures and the application behavior of the client device. The actual energy consumption may depend on many factors, such as the implementation of each interface and an uplink and downlink traffic service characteristics that will utilize a selected WNIC. As different terminals use different components, the energy consumption may vary between them. Therefore, in certain embodiments, an accurate model may have to be generated individually for each client device model.

In certain embodiments, a power estimator application may be provided that is based on test data collection and analysis. The power estimator application on the client device may accurately estimate real time power consumption for each specific wireless network connectivity (WNIC) choices. The power estimator application may run simultaneously on the client device while other applications are run. Example types of applications may include, but are not limited to, gaming, interactive video, audio, email, browsing, etc. Information may be collected and statistically processed for each user to provide an indication of each application's energy model per WNIC. In this regard, the power estimator application may provide useful measures for an energy based handoff scheme. For example, statistical data may be collected and used as historical data in VHO algorithms that factor history in power consumption. Furthermore, for each choice of wireless connectivity, a list of relevant contexts may be created that are customized to a user environment, user behavior, and an application. More specifically, measurement data provided by the power estimator application may be post processed in relation to the other contextual information collected by the client device (e.g., time of day, location, interference, etc.) to determine (or define) an average energy estimation. For example, in an embodiment, an average energy estimation, Average Energy, may be determined according to the following function.

Average Energy=f(Location,Application,User Behavior,WNIC, . . . )

In the equation for Average Energy, f may effectively be a linear summation of different energy components specific to the identified variables. For example, in an embodiment, a total energy, Total Energy, may be determined according to the following example equation.

Total Energy(Application,WNIC)=E₁+E₂+E₃+ . . . +E_{N}+E_{Comm}

En (n=1, 2, 3, . . . N) may be different “baseline” energy components which are significant contributors to a client device's energy consumption. These components may include different parameters and may have different WNICs and applications.

An energy cost of communication may factor WNIC RRC state machines and interactions of application traffic patterns with them. In certain embodiments, network and RRC state machine parameters may be extracted from existing networks. Network parameters may have a significant impact on the energy consumption. Example network parameters may include configurations of discontinuous reception (DRX) parameters, beacon intervals, scheduling, and power control. The complexity of the model may vary in different embodiments. The energy model may be a per device model. For example, power traces of a client device may be captured by a power monitor containing different fields such as average instant power and time stamps for a given sampling rate. A test session may be used to measure different RRC power levels per state for each WNIC. In order to trigger state promotion, the client device may be made to idle for a sufficient amount of time and then a next packet may be sent from a server to the client device. The test pattern may ensure that the power trace covers the complete tail interval.

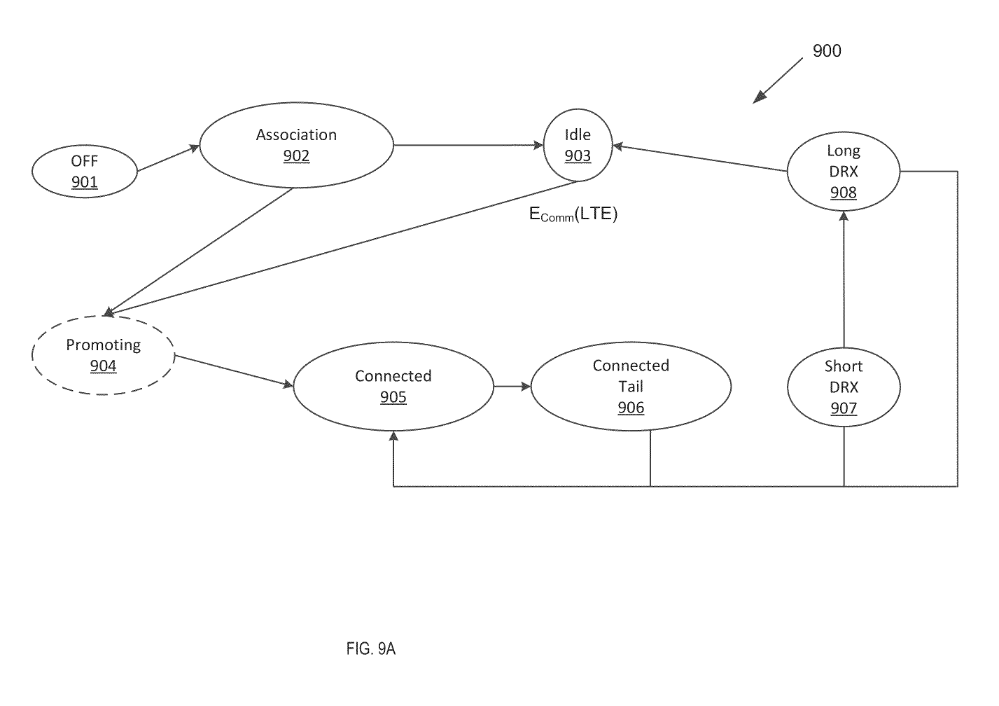

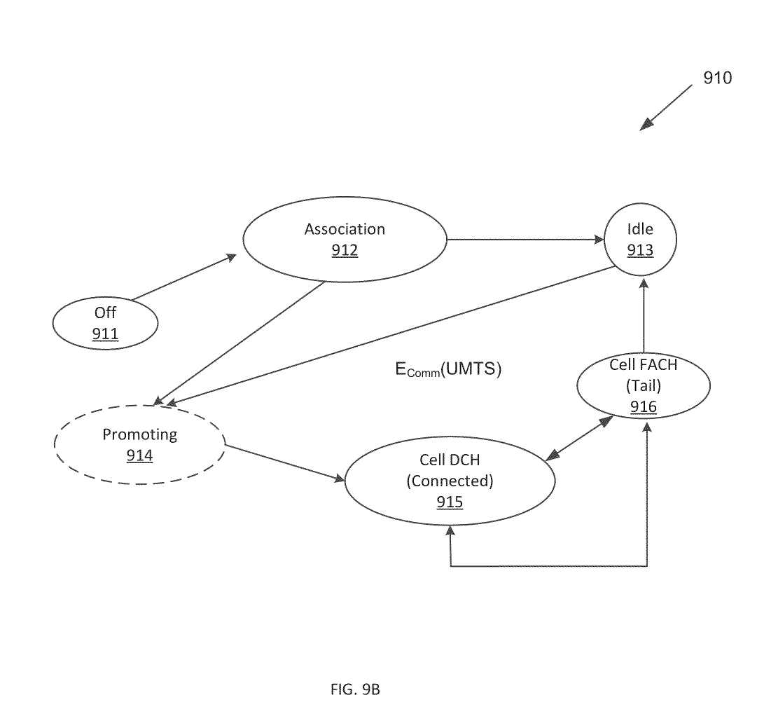

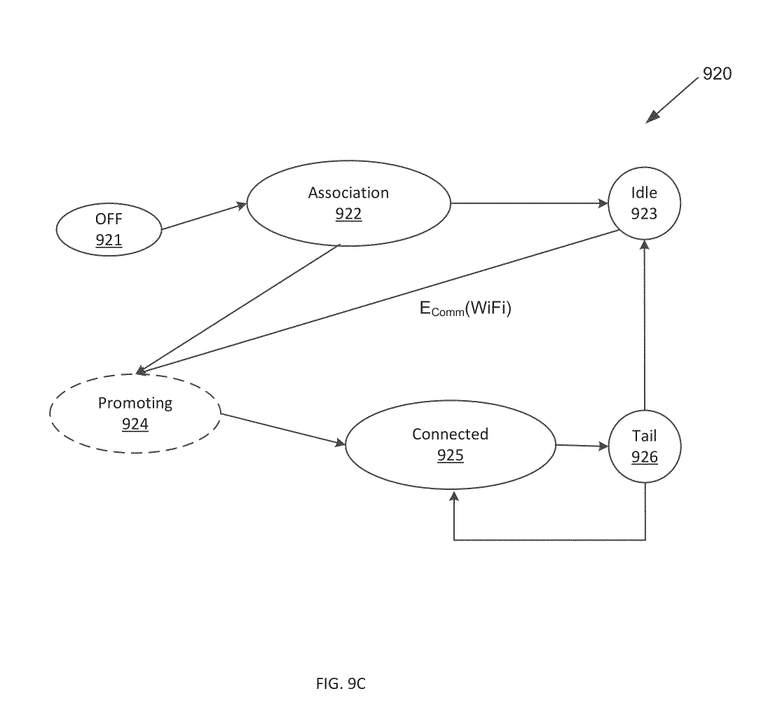

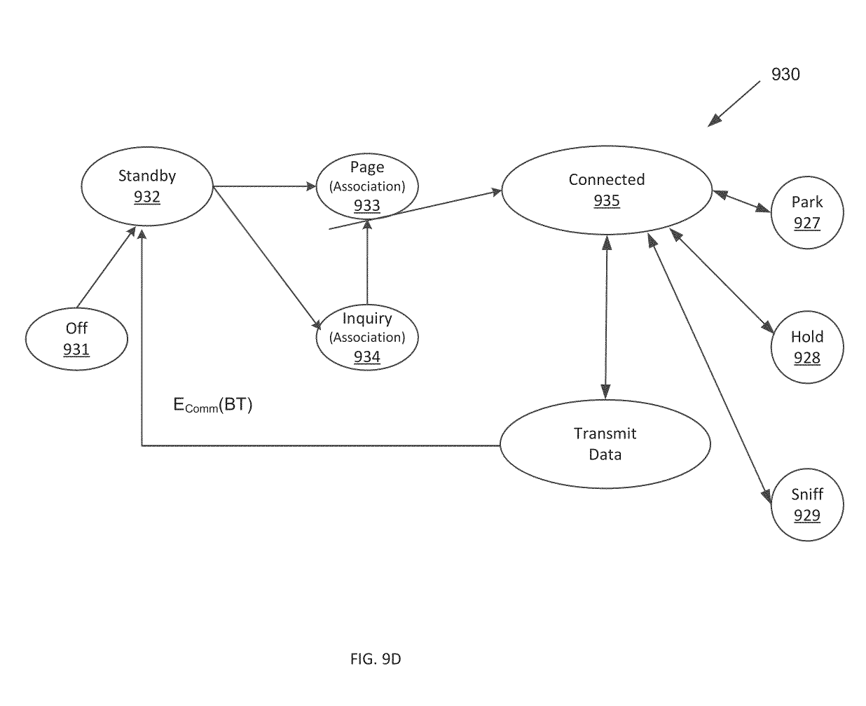

FIGS. 9A, 9B, 9C, and 9D illustrate diagrams for RRC state machines for different wireless standards, according to certain embodiments. FIG. 9A illustrates an example RRC state machine diagram 900 for LTE, according to certain embodiments. FIG. 9B illustrates an example RRC state machine diagram 910 for UMTS, according to certain embodiments. FIG. 9C illustrates an example RRC state machine diagram 920 for Wi-Fi, according to certain embodiments. FIG. 9D illustrates an example RRC state machine diagram 930 for Bluetooth (BT), according to certain embodiments. Several states in the RRC state machine diagrams 900, 910, 920, and 930 may be different per WNIC, and each may have different power levels and functionality.

In FIG. 9A, the RRC state machine diagram 900 for LTE may include an off state 901, an association state 902, an idle state 903, a promoting state 904, a connected state 905, a connected tail state 906, a short discontinued receiver (DRX) state 907, and a long DRX state 908. After activation from the off state 901, a WNIC may go to the association state 902 which may perform access network discovery and association with an eNB. The WNIC may be in the association state 902 for a period of time depending on the time to find an accessible eNB and to authenticate to the eNB.

In the idle state 903, the client device may stay in an inactive low power mode. For example, during the idle state 903, the client device may stay mostly in a sleep mode but may wake up at times to look for connection arrivals from a network, which may be indicated by paging signals for instance. When a paging signal arrives, the client device may transition to the promoting state 904. The client device may enter the promoting state 904 to accommodate a signaling time during which a network needs to assign proper resources to the client device. After a certain period of time defined by the promoting state 904, the client device may transition to the connected state 905. The client device may remain in the connected state 905 during the entire connection.

Once the connection has ended, the client device may transition to the connected tail state 906. In the connected tail state 906, the client device may wait for a timer to expire. If no connection has arrived after the timer expires, then the client device may move to the short discontinued receiver (DRX) state 907. Otherwise, the client device may return back to the connected state 905. The short DRX state 907 is similar to the idle state 903 which has a cycle time and an on time. If a request arrives before a timeout of the short DRX state 907, the client device may go back to the connected state 905. Otherwise, the client device may go to the long DRX state 908. If a connection request arrives before a time out of the long DRX state 908, the client device may switch back to the connected state 905. Otherwise, the client device may go to the idle state 903. The timeout for the idle state 903 may be long compared to other states. For instance, as an example, the timeout for the idle state 903 may be approximately 11.6 seconds, as compared to tens of milliseconds for most other states.

In FIG. 9B, the RRC state machine diagram 910 for UMTS includes an off state 911, an association state 912, an idle state 913, a promoting state 914, a cell dedicated channel state (DCH) 915, and a cell forward access channel (FACH) state 916. The RRC state transitions in directions from the idle state 913 to the cell DCH state 915, the cell FACH state 916 to the cell DCH state 915, and the idle state 913 to the cell FACH state 916 may be considered as promotions. The reverse directions may be considered demotions. Promotions may switch from a state with lower radio resource and radio power consumption to another state requiring more radio resources and power. The radio may remain in the idle state 913 in the absence of any network activity. Transitions to the higher power states (e.g., the cell DCH state 915 and the cell FACH state 916) may be initiated when the network is active. For example, the cell DCH state 915 may be a high power state as the WNIC reserves a dedicated channel to the client device and ensures high throughput and low delay for transmissions. The cell FACH state 916 may consume lower power (e.g., about half) than the DCH state 915 as it shares a channel with other devices. The cell FACH state 916 may be used when there is a small amount of traffic to transmit. The idle state 913 may consume, for example, about one percent of the power in the DCH state 915.

In FIG. 9C, the RRC state machine diagram 920 for Wi-Fi may include an off state 921, an association state 922, an idle state 923, a promoting state 924, a connected state 925, and a connected tail state 926. The RRC state machine 920 for Wi-Fi may experience a high initial cost during association with an AP. Wi-Fi phones may use a power save mode (PSM) to reduce the cost of maintaining the association.

In FIG. 9D, the RRC state machine diagram 930 for BT may include an off state 931, a standby state 932, a page state 933, an inquiry state 934, a connected state 935, a transmit state 936, a park state 937, a hold state 938, and a sniff state 939. The standby state 932 may be an initial state for BT devices. In the standby state 932, a BT device may be in a standby mode. In the standby state 932, a BT WNIC may listen periodically for messages, such as every 1.28 seconds for instance. When a unit wakes up, it may listen on a set of 32 hop frequencies defined for that unit. The BT WNIC may initiate a connection procedure. In the case an initiating device becomes a “master”, a connection may be initiated by a page message (e.g., in the case of a known address), or by inquiry message (e.g., in the case of an unknown address) followed by a page message. The page state 933 may have several stages. There may be three power saving modes that act as idle states, such as the hold state 928, the sniff state 929, and the park state 927. The hold state 928, the sniff state 929, and the park state 927 may allow power savings of BT network nodes (e.g., piconet members) which are currently not active. More specifically, the master may put slaves into the hold state 928 if no data needs to be transmitted. The sniff state 929 may be used for the slave device to listen to the piconet at a reduced rate. For instance, its duty cycle may be reduced to save power. The park state 927 may hold the client device in sync to the piconet, but at the same time disable its participation in the traffic. Parked devices may still listen periodically to the traffic of the master to resynchronize or check on broadcast messages.

It is important to note that from a battery life perspective in client devices (e.g., mobile device), the power consumed for a radio network in its idle state may be even more significant than the active or connected power states. For instance, given typical use models, some mobile devices may only communicate for a small percentage of the time the client device is actually on. In that regard, a WNIC power consumption of each RRC model in the idle state (e.g., the hold state 928, the sniff state 929, and the park state 927) may be a significant factor. For example, BT is optimized to be in an extremely low-power state operating at only a 2% power duty-cycle and consume a typical power on an order of 1 mW while still being able to perform discovery and connection setup. Wi-Fi, on the other hand, may be based on Carrier Sense Multiple Access (CSMA), and despite advancements of the power saving mode (PSM), the underlying MAC design may generate significant power consumption in an idle state as compared to BT.

In certain embodiments, additional measurements may be required to estimate energy in the connected states. Example measurements may be related to data rate (e.g., uplink, downlink, etc.), data size, parameters relating to a setup of a network, wireless network conditions, etc. These measurements may be used to model a total energy per WNIC, such as by estimating parameters for connection time, EConnected.

To achieve a more accurate energy consumption model, a trace-driven ecosystem-based energy model may be provided to perform two levels of simulation on a network edge device. Initially, a network model simulator may collect and process packet traces of an existing radio communication link. The packet traces may then be run on RRC power state machines of different RATs. The network model simulator may adjust packet time stamps to compensate for the difference in different RAT delay behaviors due to their state machine differences. These delays may usually relate to state promotions and may need to be removed for extracting actual traffic patterns.

An output of the network model simulator may be applied to a power model simulator. The output may consist of an array of packets with adjusted timestamps (e.g. in ascending order) as well as the RRC states of the client device at any time. The power model simulator may take the output of network model simulator and may calculate energy consumption based on a power model, extracted though network measurements. In this model, for instance, the total energy may be split into four components: promotion, data transfer, tail, and idle. For data transfer energy, a linear model may be determined as a function of uplink and downlink throughput. The actual data transfer power consumption may be computed as a linear combination of these throughputs plus a constant. These function parameters may be derived by measurements performed in the client device.

In an embodiment, the total energy per WNIC, Total Energy (App, WNIC), may then be estimated in real time according to the following example equation.

$$Total Energy ( App , WNIC ) = {E}_{1} + {E}_{2} + {E}_{3} + … + {E}_{N} + {E}_{Comm} = {E}_{1} + {E}_{2} + {E}_{3} + … + {E}_{N} + ( {P}_{Assoc} \times {t}_{Assoc} ) + ( {P}_{idle} \times {t}_{idle} ) + ( {P}_{tail} \times {t}_{tail} ) + … + {E}_{Connected}$$

En (n=1, 2, 3, . . . N) are different “baseline” energy components which may be significant contributors to a client device's energy consumption. These components may include different parameters and may have different WNICs and applications. P may be the power of each RRC state, and t is a total time that a WNIC stays in each RRC state. Assuming linear modeling of a connection time as a function of uplink and downlink traffics, the connection time, E_{Connected}, may be determined according to the following example equation.

E_{Connected}=a_{UL}R_{UL}+a_{DL}R_{DL}+b

R_{UL} and R_{DL} may be uplink and downlink data rates, respectively. Parameters a and b may represent network dependent constants to reflect the linear relationship of E_{connected} with the data rate. The parameters a and b may be estimated per WNIC based on measurements performed.

In an embodiment, the overall energy per WNIC and the current application may be estimated according to the following example equation.

Total Energy(App,WNIC)=E1+E2+E3+ . . . +EN+(P_{Assoc}×t_{Assoc})+(P_{idle}×t_{idle})+(Pₜₐᵢₗ×tₜₐᵢₗ)+ . . . +a_{UL}R_{UL}+a_{DL}R_{DL}+b

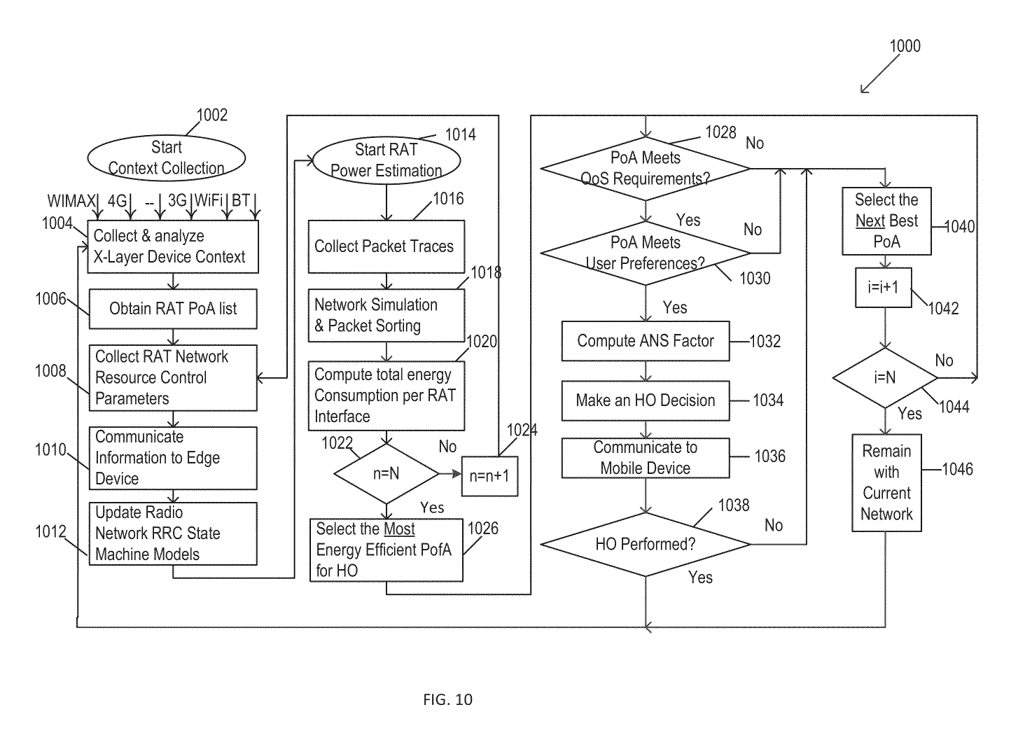

FIG. 10 illustrates an exemplary flowchart for an ecosystem-based ambient network sensing (ANS) system 1000 for recommending a candidate network for VHO, according to certain embodiments. In some embodiments multiple blocks may be utilized for performing a VHO. Blocks 1002, 1004, 1006, 1008, and 1010 may represent the process taking place in a client device within an ecosystem. At block 1002, the context collection process may be initiated. In certain embodiments, it may be assumed that power measurements leading to an overall energy modeling (e.g., step 802 in FIG. 8) may have already taken place and a relevant energy related context may be determined at different protocol layers. At step 1004, a cross-layer context collection may be initiated based on an overall energy model. As indicated above, cross-layer contextual information collection may comprise information or parameters from two or more open systems interconnection (OSI) layers. At step 1006, a network monitoring entity running on the client device (e.g. based on 802.21 MIH, ANDSF, etc.) may determine a list of available point of attachments (PoAs) based on a location of the client device. The list may primarily include non-ecosystem-based network APs or base stations that the client device may communicate with.

At block 1008, the RRC model power levels per state may be collected or updated. For example, appropriate interfaces to the RRC engine may be accessed or power measurements may be taken, such as described herein. In some instances, this may be an optional step that may occur on regular intervals as a maintenance cycle, or as an event driven mechanism that may be triggered by indications that RRC states parameters have been changed by the network. If such changes are indicated, then at block 1010, a new set of RRC parameters may be communicated by the client device to a processing engine at a network edge device.
i. In certain embodiments, blocks 1010 and beyond may be performed by the network edge device. It should be appreciated that in other embodiments, a different combination of steps may be performed by the client device and the network edge device. At block 1012, an RRC state machine simulator may be updated with any changes in the model parameters. At block 1014, the network edge device may initiate a real time power estimation process. At block 1016, packet traces initiated from the client device may be collected. At block 1018, the packet traces may be post processed by a network simulation and packet sorting tool. The output of the network model simulator, comprising of an array of packets with adjusted timestamps (e.g. in ascending order), and the RRC states of the client device are applied to a power model simulator. At block 1020, a power model simulator takes an output of the network model simulator and calculates an energy consumption based on a power model, which is extracted though network measurements. Optionally, the energy consumption may be estimated for the total energy per application using the equations disclosed above. At blocks 1022 and 1024, the process of RRC parameter collection and communication to the network edge device is repeated for all available network PoAs obtained by the client device. In an embodiment, real time cross-layer contextual information may only be collected for a current connection. Historical values of contextual parameters may be used for other PoAs. At block 1026, an optimally energy efficient PoA may be selected. At blocks 1028 and 1030, the PoA may be evaluated to determine if QoS and user requirements are met. If these requirements are met, then at block 1032, a metric for selecting a candidate RAT PoA (also referred to herein as an ANS factor) may be computed. Various algorithms may be used to determine the metric. In an embodiment, a MDCM algorithm may be implemented. The ANS factor may be represented by a number between 0 and 1, which may represent the priority of switching to an optimal (e.g., best) network. Optionally, the ANS factor can be calculated by finding the fraction for each energy amount for the application divided by the total sum of energy for the wireless network interface.

At block 1034, a handoff decision may be made based on other contextual handoff parameters. At block 1036, the decision may be communicated back to the client device. At block 1038, the handoff may be either performed or not. If the handoff is performed, then the process may be repeated, as represented by the arrow back to block 1004. If the handoff is not performed, then an alternative (e.g., next best) PoA may be selected at block 1040. Similarly, if the PoA does not meet QoS or user requirements at blocks 1028 and 1030, then at block 1040 an alternative (e.g., next best) PoA may be selected. At blocks 1042 and 1044, it is determined if any alternative PoAs remain available for selection. If no alternative PoAs are available, then the current network is used at block 1046. The process may be repeated, as represented by the arrow from block 1046 back to block 1004.

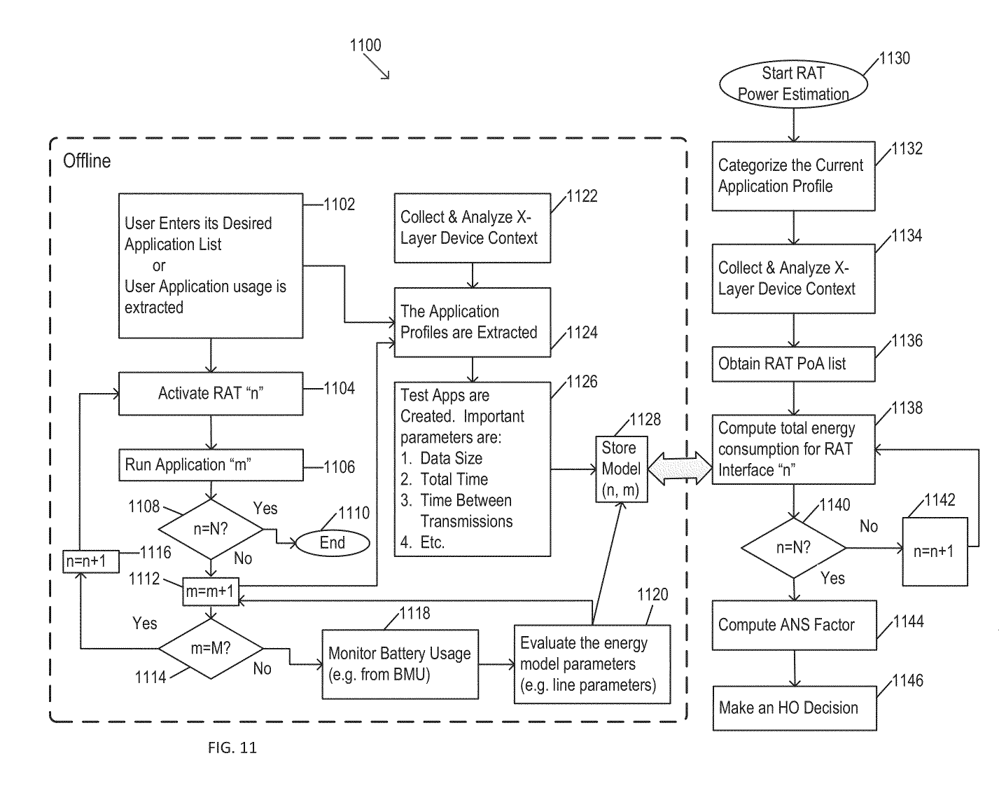

FIG. 11 illustrates a block diagram of an energy estimation method 1100 for a handoff decision, according to certain embodiments. The method 1100 may provide for a simplified deductive model process that enables various computations to be performed offline. In one embodiment, such offline processing may be partitioned to be performed on a network edge device or in the cloud, allowing for power intensive processing aspects to be performed off of the mobile device. The measurement of total energy consumption may be done by creating different scenarios and measuring the energy (e.g., monitoring energy or battery usage). The offline processing may be updated in cycles with the duration between updates being adjustable depending on various sensed factors (e.g., detection of movement to another location, frequency of application use, etc.) For example, blocks 1102 through 1128 may be performed offline in the embodiment shown, as represented by the dotted box encompassing blocks 1102 through 1128. In other embodiments, varying combinations of these functions may be performed offline.

At block 1102, a user may identify one or more applications (e.g., by providing an application list) for the energy estimation. Alternatively, user application usage may be extracted to identify the applications for the energy estimation.

At block 1104, one of the available RATs may be activated. At block 1106 one of the applications identified at block 1102 may be run. If at block 1108 it is determined that no available RATs remain to be activated, then the method 1100 may be ended at block 1110. Otherwise, at blocks 1112 and 1114 it is determined if any applications remain to be run. If there are still additional applications to be run, then at block 1118, battery usage may be monitored (e.g., from BMU) for the client device for the specific RAT activated at block 1104 and application run at block 1106. At block 1120, energy model parameters (e.g., line parameters) may be evaluated for the specific RAT activated at block 1104 and application run at block 1106. In one embodiment, evaluation of energy model parameters may comprise creating a table and associating the application and RAT (m and n) with the measured energy. Other contexts or parameters can also be included. Optionally, the table may also be sorted with the lowest energy at the top and the greatest energy usage at the bottom.

Blocks 1118 and 1120 may be repeated for any additional applications to be run. When no additional applications remain to be run, then the next available RAT may be activated, as represented by block 1116 and loop back to block 1104.

At block 1122, cross-layer contextual information may be collected and analyzed. As indicated above, cross-layer contextual information may comprise information or parameters from two or more open systems interconnection (OSI) layers. At block 1124, application profiles may be extracted based on the contextual information. At block 1126, test applications may be created. Example parameters that may be applicable to the test applications may include, but are not limited to, data size, total time, time between transmissions, etc. At block 1128, a model for the RAT and application may be stored.

At block 1130, the RAT power estimation process may be initiated. In the embodiments shown, blocks 1130 through 1146 may be performed online. At block 1132 a current application running on the client device may be categorized based on application profiles that were previously generated offline, such as generated from blocks 1122 through 1126. At block 1134, cross-layer contextual information associated with the client device may be collected and analyzed. As indicated above, cross-layer contextual information collection may comprise information or parameters from two or more open systems interconnection (OSI) layers. At block 1136, a RAT PoA list may be obtained. For example, in an embodiment, the RAT PoA list may be received from a server on the cloud. In another embodiment, the RAT PoA list may be derived from multi-layer network monitoring with active and passive scanning. At block 1138, a total energy consumption for one of the RAT PoAs (or interface corresponding to the RAT PoA) may be computed. At block 1138, stored models are obtained from block 1128 and the total energy consumption is computed for the specific RAT. At blocks 1140 and 1142, it is determined if there are any additional RAT PoAs remaining. If additional RAT PoAs remain, then a total energy consumption for the remaining RAT PoAs are computed, as indicated by the arrow from block 1142 back to block 1138. When no additional RAT PoAs remain, a metric for selecting a candidate RAT PoA (or ANS factor) may be computed at block 1144. The ANS factor may be computed according to equations disclosed below. At block 1146, a handoff decision is made based, in part, on the ANS factor.

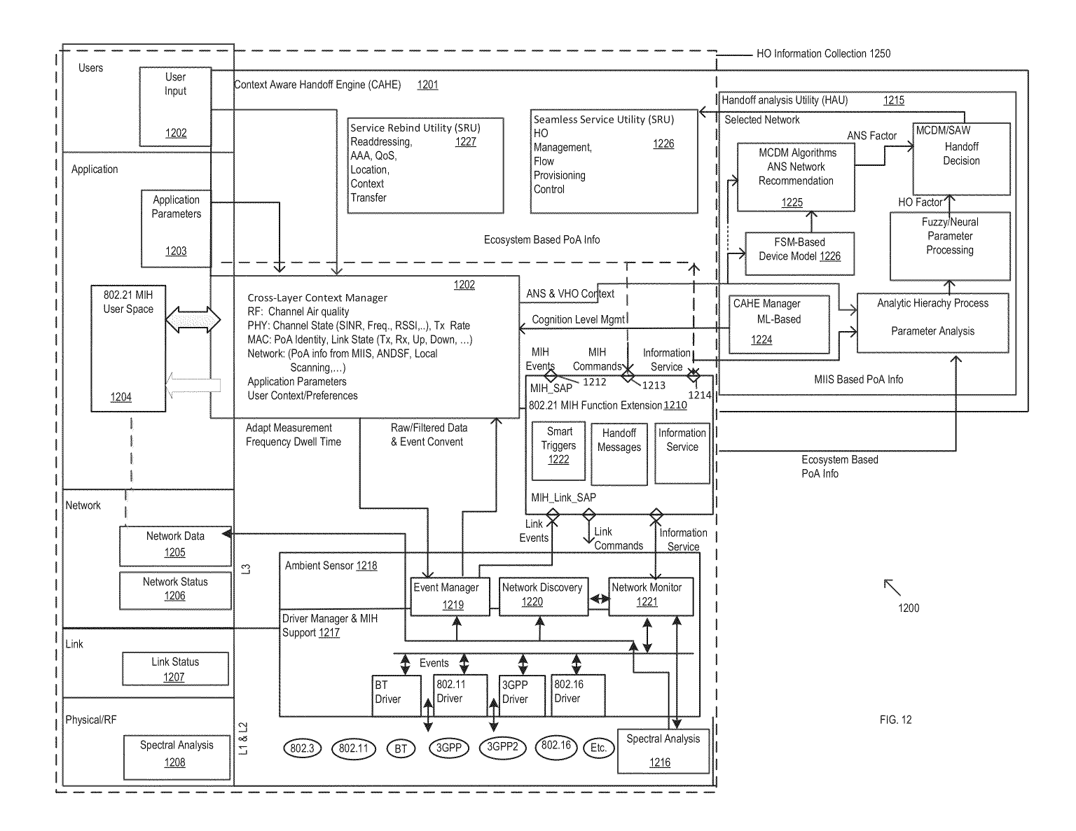

FIG. 12 illustrates an exemplary block diagram of an ANS system 1200 as middleware on a client device, according to certain embodiments. The ANS system 1200 is shown including a context aware handoff engine (CAHE) module 1201 and a context manager (CM) module 1202. It should be appreciated that the discussions herein regarding CAHE modules and CM modules (e.g., as discussed in FIGS. 5 and 7) may also apply to the discussion of FIG. 12. For the sake of brevity and clarity, every feature and function applicable to CAHE modules and CM modules are not repeated here.

The CAHE module 1201 and the CM module 1202 may collect handoff contextual information to be used for handoff analysis and execution. For example, contextual information collected may relate to user input 1202, application parameters 1203, MIH user space 1204, network data 1205, network status 1206, link status 1207, and spectral analysis 1208. A handoff information collection section 1250 of the ANS system 1200 is shown by a dotted line.

The CAHE module 1201 may play a role in the handoff information collection process, but may also play a role in handoff analysis and execution. The CAHE module 1201 is shown including a service rebind utility (SRU) module 1227, a seamless service utility (SSU) module 1226, and a handoff analysis utility (HAU) module 1215, which are discussed in further detail herein.

A media independent handover function (MIHF) extension module 1210 which takes the role of encapsulation of the higher layers from layer 1 (L1) and layer 2 (L2). These lower layers may be accessed by different functions within the MIHF extension module 1210 to retrieve information to detect, prepare, and execute a VHO. Higher layers may demand this information and may be referred to as a MIH user space (MIHU) 1204. The MIHF module 1210 may provide a service access point (SAP) to both higher and lower layers so that they may exchange service messages. The MIHF module 1210 may be considered as a logical entity that facilitates handover decision making. The MIHU module 1204 may make handover decisions based on inputs from the MIHF module 1210 and may include three entities referred to as a media independent event service (MIES) module 1212, a media independent command service (MICS) module 1213, and a media independent information service (MIIS) module 1214. The MIES module 1212 may provide events occurring in L1 and L2 to the MIHU module 1204 when requested by the MIHU module 1204. The MIES module 1212 may cover multiple events including, network initiated events (e.g. operator preferences, load balancing, information), predictive events (e.g., links going up, links going down), state change events (e.g., link up, link down, changes in link parameter). The MICS module 1213 may provide a control mechanism for the MIHU module 1204 to take charge over the lower layers by facilitating a set of commands. The MIIS module 1214 may equip the MIHF module 1210 with an ability to discover its available network environment through collecting information that the upper layers need to make decisions. The information elements may refer to a number of parameters including operator ID, roaming partners, cost, a list of available networks and location of each PoA, PoA capabilities, vendor specific information, QoS and security parameters, etc.

Using the information collected by the MIES module 1212 and MIIS module 1214, the HAU module 1215 implemented as a middleware in the MIHU space 1204 may be able to make a decision on whether to switch from one PoA to another. Commands may enable executing the handover, but may also help with setting different parameters in the lower layers elements. An actual handoff decision by the HAU module 1215 may require more contextual information. In an embodiment, the ANS system 1200 may also include an extension (not shown) to MIHF that provides a multi-RAT approach that may go beyond the scope of RATs supported by 802.21 MIH. For example, the extension may capture information that may be communicated by a network edge device through protocols such as IEEE 802.11k (e.g., for radio resource management) and IEEE 802.11v (e.g., for wireless network management). The extension may also gather RF channel analysis information that may be communicated by the spectral analysis module 1216.

In an embodiment, a driver management and MIH support module 1217 may be provided. The driver management and MIH support module 1217 may be implemented below the extended MIHF module 1210 layer and contain device drivers of network cards integrated in the client device. For example, the drivers of WLAN, 3G, 4G, BT, and WiMAX networks may be stored in the driver management and MIH support module 1217. The main task of the driver management and MIH support module 1217 is management of different networks cards and provision of services to an ambient sensor module 1218.

The ambient sensor module 1218 may be above the driver management and MIH support module 1217 and below the MIHF module 1210. The ambient sensor module 1218 may have three major modules: an event manager module 1219, a network discovery module 1220, and a network monitor module 1221. The event management module 1219 may manage received events generated from different interfaces drivers in a mobile node. The event management module 1219 may also be connected to an optional spectral analysis module 1216 which may provide the event manger module 1219 with channel “air quality” and interference events to avoid contaminated channels. The event management module 1219 may report specific events that are indicative of changes in link characteristics or air quality on a local or remote entity. The event management module 1219 may be implemented in a kernel space. The raw events may be filtered to focus on link state or device energy consumption events, such as high battery drain rate. Alternatively, the raw events may be directly applied to the MIHF module 1210 (e.g., through the MIH-Link_SAP) and may be filtered within the smart triggers module 1222. Certain events, such as messages link up or down, may be communicated to the network discovery module 1220. In this regard, regular kernel functions may be mapped directly into an event manager API to send or receive to the network discovery module 1220.

The network discovery module 1220 may provide the MIHF module 1210 with an up-to-date list of available PoAs. For example, the list may be obtained by autonomously scanning for such information (e.g., as provided by the spectral analysis module 1216); by incorporating network information from a network edge device within the ecosystem; by using MIIS information received from a server (e.g., MIH server) and transferred by the MIH user 1204 to the network discovery module 1220; by using an ANDSF protocol; etc.

To reduce the frequency of sensing and to save energy in the client device, a form of smart scanning may be deployed by engaging a spectral analysis module 1216. For example, using the spectral analysis module 1216, the polluted (or interfered) or busy channels may be excluded from scanning, which may also significantly reduce VHO delay. The spectral analysis module 1216 may, for instance, be implemented in the client device as shown in FIG. 12, or implemented at a network edge device to further save energy. To ensure preservation of QoS parameters (e.g., meeting the application's delay and jitter requirements) while the network discovery is ongoing, the smart scanning may switch between scanning and data reception within the network discovery module 1220. Before a scan, a prediction of an expected scanning time may be evaluated in order to ensure that an overall iteration time does not exceed the maximum allowed interruption time for the application. If this is the case, the scanning would not continue and the client device may switch back to the existing communication channel for data frame delivery. When a scan is performed through internal control signaling (e.g. using 802.11k or MIH signaling), the client device may inform the network edge device about its state change to scanning mode and may request that it buffer the data that is targeted to the client device. This may require the network edge device to have access to the data stream targeted to the client device. The combination of network discovery module 1220 and the spectral analysis module 1216 may improve the handoff delay by determining a subset of networks where the client device may have good reception. This may short list the available PoAs and reduce scanning time. This may also be done by processing the signals received from APs) or base stations (BSs) as they periodically send route solicitation signals to inform client devices about a network prefix. The network discovery module 1220 (or the connection manager in the client device) may receive these signals. If the message contains a new prefix, it may be selected as a new available PoA.

To save energy and ensure QoS, the network discovery process may be managed by the HAU module 1215. The management may be performed using energy and QoS related triggers, such as unusual or high battery drain rates, increased level of interference (e.g., measured by the spectral analysis module 1216), low SNR, or a long service interrupt estimation. These triggers and their rate may be either static or dynamically adjusted, such as by machine learning algorithms.

In coordination with the spectral analysis module 1216, the network monitor module 1221 may be in charge of monitoring and evaluating wireless channel conditions. The network monitoring module 1221 may collect real time L1 and L2 contextual information by measuring appropriate raw data. The measurements may also be based on network side contextual information collected by a network edge device regarding a current PoA status. On the client device side, contextual information may include current application and service meta data, location information, measure TX power, jitter or data rates, or real time battery information. The network side information may include PoA status such as its current load, SINR, instantaneous data rate, capacity, etc. Other link related parameters such as link layer throughput, link quality, loss rate, and contention rate may also be collected by network monitoring functions of the client device and the network edge device. In an embodiment, this contextual information may be enhanced by a spectral analyzer embedded in the network edge device. This contextual information may be filtered or communicated as raw data to the CM module 1202. The network monitor module 1221 may collect and manage parameters related to link behavior and VHO. The network monitor module 1221 may provide collected information from the link layer to the HAU module 1215 for an eventual handover initiation and decision. As such, the network monitor module 1221 may keep the client device informed about its connectivity to the associated PoA and the available resources in the client device.

The CM module 1202 may receive the lower layer raw or filtered context from the ambient sensor module 1218 and the MIHF module 1210. The CM module 1202 may also receive contextual information through direct access to these layers. The CM module 1202 may play a critical role when various parameters may influence the robustness and the efficiency of the VHO procedure. A rich set of context may be provided for the HAU module 1215 so that it may jointly analyze the cross-layer contextual information in order to accurately detect the energy and radio resource consumption. In this way, it may select the most efficient network in ambient network sensing. Some examples of important contextual data may include WNIC-specific energy consumption values per RRC state; energy-profile and residual PoA utilization time for various service types; and delay, throughput, and energy overheads introduced during past handoff execution phases. In addition to provision of an energy consumption evaluation reference, the contextual information may also help determine a correct time for VHO decision and consistent QoS deterioration inference measures. The required level of context awareness may be adjusted to heterogeneous network dynamics (e.g., operating environment, mobility, and network density) and a current energy state of the client device (e.g. battery drain rate). The CM module 1202 may provide the HAU module 1215 with the contextual information for accurate estimation of energy state based on various historical and real time contextual parameters, such as those determining an energy consumption rate of current PoA, current channel state, location, information on service residual utilization time per PoA, etc. The HAU module 1215 may analyze and assess the accessible PoA choices and may coordinate an energy efficient context collection and network discovery process. For better accuracy in PoA selection, a proper balance between the detail and accuracy of the derived context may be established based on extraction of proper contextual information from raw energy data. This may be achieved by a CAHE manager module 1224 through analytical algorithms such as machine learning.

A finite state machine (FSM) based device model module 1226 may provide estimations of an energy consumption per interface state as a multi-parametric function of the client device and PoA parameters. Accordingly, the FSM based model module 1226 uses a variable combination of both historical and real time data to estimate the energy consumption associated with each available PoA. This variable combination may be established by adjusting a required level of context awareness for the handoff. As a result, a criterion for concluding a suitable context derivation method may be a capability to control the context derivation method on energy-related raw data by dynamically adjusting both the detail and the accuracy of the derived context. In an embodiment, this may be implemented by the CAHE manager module 1224 using a machine learning algorithm. Based on analysis of the handoff scenario, the CAHE manager 1224 may provide the CM module 1202 with the ability to dynamically adjust the context processing and collection control. This may be done indirectly by providing the CM module 1202 with appropriate level of adaptability and cognition to control measurement, duration, and frequency of the network monitoring module 1221.

The HAU module 1215 may include an ANS network recommendation module 1225 that may recommend a candidate RAT PoA (e.g., an optimal RAT PoA) for handoff. In an embodiment, the ANS network recommendation module 1225 may be an energy aware multi-criteria decision algorithm (MCDA) that takes contextual data from the CM module 1202, as well as inputs from the FSM-based device model module 1226, and provides recommendation on the PoA. In this regard, the ANS network recommendation module 1225 may evaluate all PoA alternatives, such as both in terms of offered QoS and energy consumption. The algorithm implemented may process the relevant context from the CM module 1202, which may include: current app characteristics in terms of energy profile, service utilization time and QoS parameters; current and all available PoA characteristics in terms of perceived energy consumptions, such as channel info, energy consumption per inference state, VHO delay, offered QoS, etc.; user preferences; etc. The recommendation may be performed for each available PoA based on a computed ANS factor (or ANS factor), which may be a metric for selecting a candidate RAT PoA. In an embodiment, the ANS factor may be a number between 0 and 1.

In some instances, additional processing may be required before making a handoff decision. Evaluation may be performed to determine whether a tagged PoA alternative is capable of supporting all requirements of a current service. As such, an energy consumption evaluation phase may account for multiple parameters, including a service energy-profile per interface state, expectations on the energy-consumption per interface state on the target PoA, handoff energy penalty, etc. In this regard, the ANS factor may then be incorporated into the network selection process that uses the ANS factor, along with other handoff decision parameters, to select a candidate RAT PoA. The HAU module 1215, the seamless service utility (SSU) 1226, and the service rebind Utility (SRU) 1227 may use the ANS factor for a handoff decision, execution management, and context transfer to the new PoA, respectively. The ANS factor and a handoff factor (also referred to as HO factor) may be integrated into a single process leading to a single factor for handoff decision, such as when the primary focus is on power consumption reduction.

### Additional Example Embodiments

Computer implemented methods, systems, and computer readable media provided herein may collect contextual information including contextual information from a physical layer and at least one other OSI layer. A handoff may be triggered based on the physical layer parameter and the at least one other OSI layer parameter.

In an embodiment, the physical layer contextual information may include a radio frequency environmental factor affecting connectivity.

In an embodiment, the radio frequency environmental factor may be interference level.

In an embodiment, performing the handoff may further include identification of a plurality of radio access technology (RAT) point of attachments (PoAs) available to a client device; calculation of a device performance metric for the plurality of RAT PoAs based on the contextual information; and calculation of a metric for selecting a candidate RAT PoA for a handoff based on the device performance metrics and quality of service (QoS) requirements for an application running on the client device.

In an embodiment, a candidate RAT PoA may be selected for handoff based on the metric for selecting a candidate RAT PoA.

In an embodiment, the device performance metric may be a metric of energy consumption by the client device.

In an embodiment, packet traces may be collected. Network simulation and packet sorting may be performed based on radio resource control (RRC) state machine models. Calculating the device performance metric for the plurality of RAT PoAs may be based on the network simulation and the packet sorting.

In an embodiment, the RRC state machine models may be updated based on the contextual information.

In an embodiment, the contextual information and the plurality of RAT PoAs may be communicated to a network edge device.

In an embodiment, a mobile device may determine the best available network which reduces energy expenditure and minimizes battery use to save energy. Once determined, the mobile device may automatically switch to the best network for conserving energy. Optionally, the mobile device may display a prompt for user input in selecting the network or recommending a change to the network based on the determination. Optionally, once the switch or handover is completed, the mobile device may display a notification the handover occurred.

For example, in an content upload situation where video, images, or other media content is uploaded to the internet (e.g., to social networks, content sharing sites, cloud storage, etc.), the mobile the mobile device may check for parameters (e.g., low interference, high RSSI) of available networks. The parameters may be obtained using network tools to monitor and scan wireless network interference along with other properties. Other parameters (such as link speed, channel frequency, security protocol, etc.) may be used in a weighted average to assist in determining the best available network. The parameter weights may be experimentally calculated and set in the system.

In an embodiment, a mobile device can monitor the remaining charge level of the battery. Once the charge falls below a threshold, the mobile device retrieves the available different wireless networks. The energy consumption of the different retrieved wireless network w₁, w₂, . . . , wₖ may be measured. The energy may be represented as Er₁, Er₂, . . . , Erₖ. The minimum and maximum energy may be determined by:

MaxEnergy=Max{Er₁,Er₂, . . . ,Erₖ}

MinEnergy=Min{Er₁,Er₂, . . . ,Erₖ}

The ANS factor for Network “W_{K}” may be calculated by:

$$ANS ( {W}_{K} ) = \frac{{E}_{k} - Min Energy}{Max Energy - Min Energy}$$

The ANS factor may be used as part of (or in place of) a Handover (HO) factor as shown above in FIGS. 10, 11, and 12 to provide a device centric perspective to triggering a handover.

Optionally, if a more energy efficient network does not exist, the currently running task which requires the energy efficient network, may be rescheduled, depending on the task priority, for a time when the mobile device is plug in for charging.

### Hardware Implementation

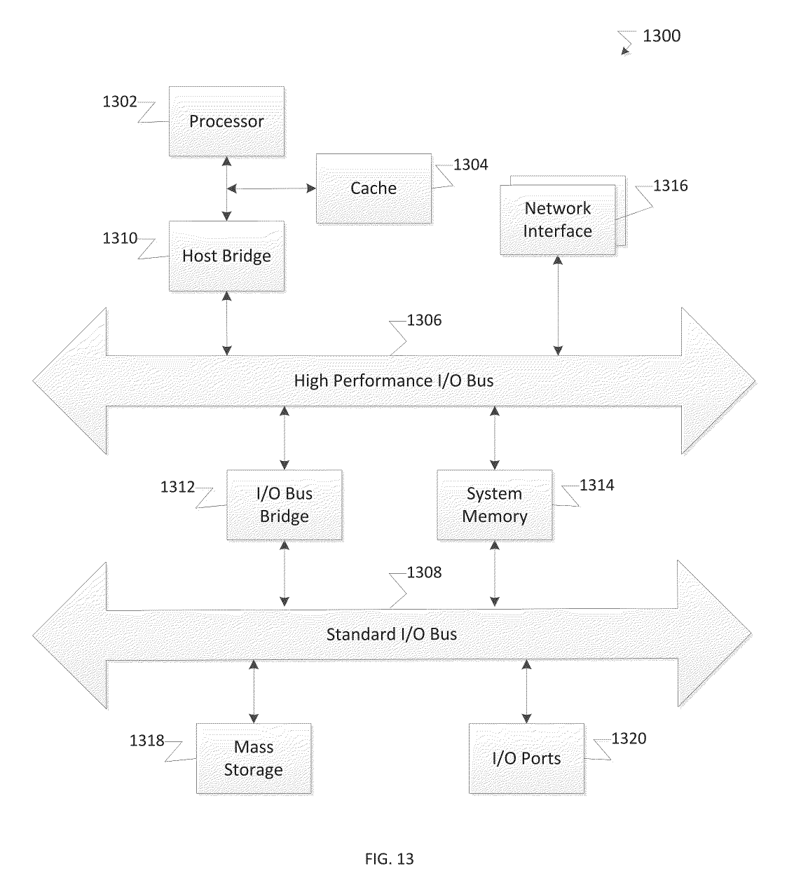

The foregoing processes and features can be implemented by a wide variety of machine and computer system architectures and in a wide variety of network and computing environments. FIG. 13 illustrates an example of a computer system 1300 that may be used to implement one or more of the embodiments described herein in accordance with an embodiment of the invention. The computer system 1300 includes sets of instructions for causing the computer system 1300 to perform the processes and features discussed herein. The computer system 1300 may be connected (e.g., networked) to other machines. In a networked deployment, the computer system 1300 may operate in the capacity of a server machine or a client machine in a client-server network environment, or as a peer machine in a peer-to-peer (or distributed) network environment. In an embodiment of the invention, the computer system 1300 may be a component of the networking system described herein. In an embodiment of the present disclosure, the computer system 1300 may be one server among many that constitutes all or part of a networking system. In an embodiment, the computer system 1300 may be implemented as the client device 701 or the network edge device 702 of FIG. 7.

The computer system 1300 includes a processor 1302, a cache 1304, and one or more executable modules and drivers, stored on a computer-readable medium, directed to the processes and features described herein. Additionally, the computer system 1300 may include a high performance input/output (I/O) bus 1306 or a standard I/O bus 1308. A host bridge 1310 couples processor 1302 to high performance I/O bus 1306, whereas I/O bus bridge 1312 couples the two buses 1306 and 1308 to each other. A system memory 1314 and one or more network interfaces 1316 couple to high performance I/O bus 1306. The computer system 1300 may further include video memory and a display device coupled to the video memory (not shown). Mass storage 1318 and I/O ports 1320 couple to the standard I/O bus 1308. The computer system 1300 may optionally include a keyboard and pointing device, a display device, or other input/output devices (not shown) coupled to the standard I/O bus 1308. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 1300, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 1300 are described in greater detail below. In particular, the network interface 1316 provides communication between the computer system 1300 and any of a wide range of networks, such as an Ethernet (e.g., IEEE 802.3) network, a backplane, etc. The mass storage 1318 provides permanent storage for the data and programming instructions to perform the above-described processes and features implemented by the respective computing systems identified above, whereas the system memory 1314 (e.g., DRAM) provides temporary storage for the data and programming instructions when executed by the processor 1302. The I/O ports 1320 may be one or more serial and/or parallel communication ports that provide communication between additional peripheral devices, which may be coupled to the computer system 1300.

The computer system 1300 may include a variety of system architectures, and various components of the computer system 1300 may be rearranged. For example, the cache 1304 may be on-chip with processor 1302. Alternatively, the cache 1304 and the processor 1302 may be packed together as a “processor module”, with processor 1302 being referred to as the “processor core”. Furthermore, certain embodiments of the invention may neither require nor include all of the above components. For example, peripheral devices coupled to the standard I/O bus 1308 may couple to the high performance I/O bus 1306. In addition, in certain embodiments, only a single bus may exist, with the components of the computer system 1300 being coupled to the single bus. Furthermore, the computer system 1300 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 1300 that, when read and executed by one or more processors, cause the computer system 1300 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 1300, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 1302. Initially, the series of instructions may be stored on a storage device, such as the mass storage 1318. However, the series of instructions can be stored on any suitable computer readable storage medium. Furthermore, the series of instructions need not be stored locally, and could be received from a remote storage device, such as a server on a network, via the network interface 1316. The instructions are copied from the storage device, such as the mass storage 1318, into the system memory 1314 and then accessed and executed by the processor 1302. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 1300 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “certain embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in certain embodiments, but also variously omitted in other embodiments. Similarly, various features are described that may be preferences or requirements for certain embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed:

1. A system comprising:
at least one processor; and
a memory storing instructions configured to instruct the at least one processor to:
collect contextual information, wherein the contextual information comprises a first parameter from a physical layer and a second parameter from at least one other open systems interconnection (OSI) layer; and
initiate a handoff to an energy efficient network based on the first parameter and the second parameter for conserving energy.

2. The system of claim 1, wherein the first parameter comprises a radio frequency environmental factor affecting connectivity.

3. The system of claim 2, wherein the radio frequency environmental factor is interference level.

4. The system of claim 1, wherein initiating the handoff further comprises:
identification of a plurality of radio access technology (RAT) point of attachments (PoAs) available to a client device;
calculation of a device performance metric for the plurality of RAT PoAs based on the contextual information; and
calculation of a metric for selecting a candidate RAT PoA for a handoff based on the device performance metrics and quality of service (QoS) requirements for an application running on the client device.

5. The system of claim 4, wherein the memory storing instructions are further configured to instruct the at least one processor to:
select a candidate RAT PoA for handoff based on the metric for selecting a candidate RAT PoA.

6. The system of claim 4, wherein the device performance metric is a metric of energy consumption by the client device.

7. The system of claim 4, wherein the memory storing instructions are further configured to instruct the at least one processor to:
collect packet traces; and
perform network simulation and packet sorting based on radio resource control (RRC) state machine models;
wherein calculating the device performance metric for the plurality of RAT PoAs is based on the network simulation and the packet sorting.

8. The system of claim 7, wherein the memory storing instructions are further configured to instruct the at least one processor to:
update the RRC state machine models based on the contextual information.

9. The system of claim 7, wherein the memory storing instructions are further configured to instruct the at least one processor to:
communicate the contextual information and the plurality of RAT PoAs to a network edge device.

10. The system of claim 1, wherein the memory storing instructions are further configured to instruct the at least one processor to:
provide, to a display, a notification the handoff to the energy efficient network occurred.

11. The system of claim 1, further comprising:
a battery, wherein initiating the handoff to an energy efficient network is based in part on a current charge level of the battery.

12. A method comprising:
collecting, with a computer system, contextual information, wherein the contextual information comprises a first parameter from a physical layer and a second parameter from at least one other open systems interconnection (OSI) layer; and
initiating a handoff to an energy efficient network based on the at least one parameter from the physical layer and the at least one other OSI layer for conserving energy.

13. The method of claim 12, wherein performing the handoff further comprises:
identifying, with the computer system, a plurality of radio access technology (RAT) point of attachments (PoAs) available to a client device;
calculating, with the computer system, a device performance metric for the plurality of RAT PoAs based on the contextual information; and
calculating, with the computer system, a metric for selecting a candidate RAT PoA for a handoff based on the device performance metric and quality of service (QoS) requirements for an application running on the client device.

14. The method of claim 12, further comprising:
selecting a candidate RAT PoA for handoff based on the metric for selecting a candidate RAT PoA.

15. The method of claim 13, wherein the device performance metric is a metric of energy consumption by the client device.

16. The method of claim 12, wherein the physical layer contextual information comprises a radio frequency environmental factor affecting connectivity.

17. The method of claim 12, further comprising:
collecting packet traces; and
performing network simulation and packet sorting based on radio resource control (RRC) state machine models;
wherein the calculating the device performance metric for the plurality of RAT PoAs is based on the network simulation and the packet sorting.

18. The method of claim 17, further comprising:
communicating the contextual information and the plurality of RAT PoAs to a network edge device.

19. The method of claim 12, further comprising:
providing a notification the handoff to the energy efficient network occurred.

20. The method of claim 12, wherein:
initiating the handoff to a energy efficient network is based in part on a current charge level of a battery within the computer system.

21. A non-transitory computer storage medium storing computer-executable instructions that, when executed, cause a computer system to perform a computer-implemented method comprising:
collecting contextual information, wherein the contextual information comprises at least one parameter from a physical layer and at least one other open systems interconnection (OSI) layer; and
initiating a handoff based on the at least one parameter from the physical layer and the at least one other OSI layer.

22. The non-transitory computer storage medium of claim 21, wherein the performing the handoff further comprising:
identifying a plurality of radio access technology (RAT) point of attachments (PoAs) available to a client device;
calculating a device performance metric for the plurality of RAT PoAs based on the contextual information; and
calculating a metric for selecting a candidate RAT PoA for a handoff based on the device performance metric and quality of service (QoS) requirements for an application running on the client device.

23. The non-transitory computer storage medium of claim 22, wherein the device performance metric is a metric of energy consumption by the client device.

24. The non-transitory computer storage medium of claim 22, further comprising:
collecting packet traces; and
performing network simulation and packet sorting based on radio resource control (RRC) state machine models;
wherein the calculating the device performance metric for the plurality of RAT PoAs is based on the network simulation and the packet sorting.

25. The non-transitory computer storage medium of claim 23, further comprising:
communicating the contextual information and the plurality of RAT PoAs to a network edge device.
